(19) United States
(12) Patent Application Publication
(10) Pub. No.: US 2002/0159010 A1
(43) Pub. Date: Oct. 31, 2002

(54) Liquid crystal display device and manufacturing method of same

(75) Inventors: Akitoshi Maeda, Tokyo (JP); Kyounei Yasuda, Tokyo (JP); Hiroaki Tanaka, Tokyo (JP); Syuusaku Kido, Kagoshima (JP)

Correspondence Address: YOUNG & THOMPSON, 745 SOUTH 23RD STREET 2ND FLOOR, ARLINGTON, VA, 22202

(73) Assignee: NEC CORPORATION, TOKYO (JP)

(21) Appl. No.: 10/132,325

(22) Filed: Apr. 26, 2002

(30) Foreign Application Priority Data
Apr. 26, 2001 (JP) 2001-130454

(51) Int. Cl. G02F 1/1335

(52) U.S. Cl. 349/113

(57) ABSTRACT

A method for manufacturing a reflective-type liquid crystal display which is capable of reducing a number of processes for a thin film transistor used in the reflective-type liquid crystal display. A reflective electrode to be connected to a source electrode of the thin film transistor and a terminal portion connecting electrode to be connected to a terminal portion lower metal film are simultaneously formed on an organic insulating film having convex and concave portions. As a material for the reflective electrode and the terminal portion lower metal film, an Al—Nd (Aluminum—Neodymium) containing 0.9% or more by atom of Nd having excellent corrosion resistance is used.

### BACKGROUND OF THE INVENTION

1. Field of the Invention

The present invention relates to a liquid crystal display device and a method for manufacturing the liquid crystal display device (LCD) which performs display by reflecting incident light from an outside and more particularly to a reflective-type or semi-transmissive-type liquid crystal display device in which the reflective electrode is made up of an aluminum (Al) alloy.

The present application claims priority of Japanese Patent Application No. 2001-130454 filed on Apr. 26, 2001, which is hereby incorporated by reference.

2. Description of the Related Art

In recent years, information society finds its way into an individual and a sophisticated information terminal having a size and weight being as small as a pocket notebook and having a large display capacity is being developed following widespread proliferation of a notebook personal computer, a PDS (Personal Digital Assistance), or a like. It is needless to say that a key to further development of these information terminals is an LCD that can provide a high performance. A reflective-type LCD is receiving attention which can provide ultra-high resolution and large capacity and which also has succeeded in reducing power required for their operations greatly and in making it be super-small and light-weight and which can provide display being so bright as to be called a “paper white display”.

FIGS. 39 and 40 show diagrams illustrating a reflective-type LCD and its manufacturing method disclosed in Japanese Patent Application Laid-open No. 2000-171794 as an example of a method for manufacturing the reflective-type LCD.

The conventional reflective-type LCD is so configured, as shown in FIG. 39, that, in a TFT (Thin Film Transistor) array substrate 223, an amorphous silicon transistor serving as a liquid crystal driving element 224 is formed on a glass substrate (not shown) and a reflective electrode (not shown) is formed on an insulating film (not shown) having gentle convex and concave parts made up of circular-shaped concave portion 233 or circular-shaped convex portion 233. The liquid crystal driving element 224 includes a gate electrode 202 formed on the glass substrate (not shown), a gate insulating layer (not shown), a semiconductor layer 204 being disposed in a manner so as to face the gate electrode 202, and a source electrode 207 and a drain electrode 208 both being disposed so as to face each other on the semiconductor layer 204.

Next, the method for manufacturing the conventional reflective-LCD is explained by referring to FIGS. 40A to 40K.

First, as shown in FIG. 40A, a glass substrate 201 is coated with a positive-type photosensitive resin 209 so as to have a thickness of 1 μm to 5 μm.

Next, as shown in FIG. 40B, exposure process is performed at low illumination using a first photomask 219 (an area of a light shielding section accounts for 20% or more and 40% or less of an area of a circular region) uniformly on the photosensitive resin 209. At this time, an amount of exposure is about 40 mJ.

Moreover, the first photomask 219 is arranged randomly in such a manner that an interval between center portions of the circular or polygonal light shielding sections being adjacent to each other is 5 μm or more and 50 μm or less.

Next, as shown in FIG. 40C, exposure process is further performed at high illumination using a second photomask 220 (portions of the light shielding section corresponding to a contact hole are made open) uniformly on a contact hole portion. Moreover, the second photomask 220 is so configured that light for the exposure passes through a signal input terminal portion and, at a same time when the exposure on the contact hole is performed, the exposure is performed at high illumination also on the terminal section. At this time, the amount of exposure is about 240 mJ.

Next, as shown in FIG. 40D, by performing development using a developing agent, portions (contact hole portions and signal input terminal portions) in which exposure has been performed at high illumination is completely removed and portions in which exposure has been performed at low illumination and being equivalent to 40% of a thickness of the film which had existed originally are left and portions in which no exposure has been performed and being equivalent to about 80% of a thickness of the film which had existed originally are left.

Next, as shown in FIG. 40E, by performing heating processing for 60 minutes at a temperature of 200° C., the resin being put in a state as described above is deformed due to thermal droop and is put in a gentle convex and concave state.

Then, as shown in FIG. 40F, an Al thin film is formed on the glass substrate 201 in a manner that its thickness is 200 nm by using a sputtering method and as shown in FIGS. 40G to 40K, patterning is performed by photolithography so that one TFT corresponds to one reflective electrode 210.

Specifically, as shown in FIG. 40G, coating with a photoresist 228 is performed a film for the reflective electrode 210 and, as shown in FIG. 40H, exposure is performed on a pulling portion and a signal inputting terminal section (not shown) for separation of every pixel electrode and then, as shown in FIG. 40I to 40K, by performing development, etching, and peeling processing, patterning is performed on the Al thin film serving as the reflective electrode 210.

Finally, the reflective electrode 210 and facing substrate (not shown) having a facing electrode on a color filter are bonded together, with a spacer being interposed between the reflective electrode 210 and the facing substrate. The liquid crystal is injected between the reflective electrode 210 and the facing substrate. On a side opposite to the liquid crystal on the facing substrate are stuck a retardation film and polarizer to finish the reflective-type LCD.

In the above description, a method for performing exposure processing on a resin by changing an amount of its exposure by using two photomasks is explained. However, it is possible to form a resin having such the shape as described in FIG. 40D by performing one time exposure processing using either of a half tone mask or a gray tone mask by which a integration value of an amount of exposure is changed for every specified region. By employing such the manufacturing method as above, the number of photo-processes can be reduced.

On the other hand, in Japanese Patent Application Laid-open No. 2000-258787, a reflective-type LCD is disclosed in which an Al—Nd (Aluminum—Neodymium) alloy is used as a material for the reflective electrode, which describes that, by using the Al—Nd alloy containing 1% or more by weight of neodymium as the material for the reflective electrode, a hillock occurring in the reflective electrode due to a history of thermal treatment can be reduced and the reflective-LCD having a high reflection rate can be obtained.

However, in the method for manufacturing the reflective-LCD disclosed in Japanese Patent Application Laid-open No. 2000-171794, its reflective electrode made of Al is formed and its terminal section is made up of two layers including a terminal portion electrode made of Ta (Tantalum) and a terminal portion connecting electrode made of ITO (Indium Tin Oxide) which is stacked on the terminal portion electrode made of Ta. The reason why two layers are used for forming the terminal section is as follows. If the terminal section is formed only using Ta, connections with an outside driving circuit are made impossible due to surface oxidation caused by a history of thermal treatment and reliability in connections is lowered. In the conventional method, a process of stacking the ITO film is employed, however, this process of forming the ITO film in the reflective-type LCD is used only for the terminal section and, therefore, the number of times of photo-processes being used for manufacturing the TFT increases. To avoid this, stacking of Al films used as the material for the reflective electrode on the Ta film is required, however, when Al is used as a material for the terminal section, corrosion (pitting corrosion) occurs easily and reliability in the connection cannot be fully ensured. That is, since the corrosion (pitting corrosion) in the conventional Al terminal cannot be prevented which reduces reliability, further processes of forming the ITO film are required. As a result, in the conventional example disclosed in Japanese Patent Application Laid-open No. 2000-171794, the photo-process to manufacture the TFT substrate is required nine times and even if both a-Si layer and n+a-Si layer are simultaneously formed by a patterning method, the photo-process is required eight times, which causes an increase in the number of processes and high costs.

Moreover, in the reflective-type LCD disclosed in Japanese Patent Application Laid-open No. 2000-258787, the Al—Nd alloy is used to achieve a reflective electrode having high reflection rate and no description of a structure of a terminal section and of reduction of a photo-process is provided. That is, even if the Al—Nd alloy is used as a material for a terminal section, when the Al—Nd alloy contains less than 0.9% by atom (0.9 atom %) of Nd (less than about 4.3% by weight of Nd), corrosion (pitting corrosion) cannot be reduced.

### SUMMARY OF THE INVENTION

In view of the above, it is an object of the present invention to provide a method for producing a reflective-type or a semi-transmissive type LCD having a reflective electrode made of an Al alloy, which is capable of reducing a number of photo-processes for manufacturing a TFT.

According to a first aspect of the present invention, there is provided a method for manufacturing an LCD serving as a reflective-type LCD having a reflective electrode formed on one substrate out of a pair of substrates being placed in such a manner to face each other with a liquid crystal layer being interposed between the pair of the substrates and operating to reflect incident light emitted from an other substrate on which the reflective electrode is not formed, the method including;

a process of simultaneously forming the reflective electrode and a terminal portion connecting electrode to be formed in a terminal portion both being made up of an alloy mainly containing Al and being excellent in resistance against pitting corrosion or of both a metal having a high melting point and an alloy mainly containing Al being excellent in resistance against pitting corrosion formed and stacked in a layer on the metal having a high melting point.

According to a second aspect of the present invention, there is provided a method for manufacturing an LCD serving as a semi-transmissive reflective-type LCD having a reflective electrode formed on one substrate out of a pair of substrates being placed in such a manner to face each other with a liquid crystal layer being interposed between the pair of the substrates and operating to reflect incident light emitted from an other substrate on which the reflective electrode is not formed and having a pixel electrode through which incident light enters from a side of the one substrate passes, the method including:

a process of simultaneously forming the reflective electrode and a terminal portion connecting electrode to be formed in a terminal portion both being made up of a metal having a high melting point and an alloy mainly containing Al and being excellent in resistance against pitting corrosion and being formed and stacked in a layer on the metal having a high melting point.

In the foregoing, a preferable mode is one wherein an element or elements to be added to the alloy containing mainly Al include any one of Nd (Neodymium), Ti (Titanium), Cr (Cromium), and Ta, or at least one group selected from groups consisting essentially of a plurality of elements including Nd, Ti, Cr, and Ta.

Also, a preferable mode is one wherein the alloy contains 2% or more, in a total amount, of the plurality of the elements to be added to the alloy.

Also, a preferable mode is one wherein the alloy contains 0.9% or more by atom of the Nd.

Also, a preferable mode is one wherein a connecting portion in which the terminal portion connecting electrode is connected to an external driving circuit is coated with a resin.

Also, a preferable mode is one that wherein includes:

a process of forming a gate electrode, a scanning line, and a terminal portion lower metal layer on a transparent insulating substrate;

a process of forming a gate insulating film on an entire surface of the transparent insulating substrate and then forming a semiconductor layer in a position being opposite to the gate electrode;

a process of forming a source electrode, a drain, electrode, and a signal line;

a process of forming a passivation film on an entire surface of the transparent insulating substrate and then forming an insulating film on the passivation film and forming, by changing an integration value of an amount of exposure for every specified region, contact holes in the insulating film over the source electrode and forming, at a same time, convex and concave portions in a display region;

a process of forming contact holes in the passivation film over the source electrode and the terminal portion lower layer metal film; and

a process of simultaneously forming the reflective electrode to be connected to the source electrode and the terminal portion connecting electrode to be connected to the terminal portion lower layer metal film, both being made up of an alloy mainly containing Al or of both a metal having a high melting point and an alloy mainly containing Al and being formed and stacked in a layer on the metal having a high melting point.

Also, a preferable mode is one that wherein includes:

a process of forming a gate electrode, a scanning line, and a terminal portion lower layer metal film on a transparent insulating substrate;

a process of forming a gate insulating film on an entire surface of the transparent insulating substrate and forming a semiconductor layer in a position being opposite to the gate electrode;

a process of forming a source electrode, a drain electrode, and a signal line;

a process of forming a passivation film on an entire surface of the transparent insulating substrate and then forming an insulating film on the passivation film and forming, by changing an integration value of an amount of exposure for every specified region, contact holes in the insulating film over the source electrode and, at a same time, convex and concave portions in a display region;

a process of forming contact holes in the passivation film over the source electrode and the terminal portion lower layer metal film;

a process of forming a pixel electrode made up of a transparent conductive film; and

a process of simultaneously forming the reflective electrode to be connected to the source electrode and the pixel electrode, and the terminal portion connecting electrode to be connected to the terminal portion lower layer metal film, both being made up of both a metal having a high melting point and an alloy mainly containing Al being formed and stacked in a layer on the metal having a high melting point.

According to a third aspect of the present invention, there is provided a method for manufacturing a liquid crystal display including:

a process of sequentially forming a metal layer, a gate insulating film, and a semiconductor layer, in this order, on a transparent insulating substrate and forming, by using a photoresist having a plurality of regions each having a different thickness which has been formed by changing an integration value of an amount of exposure for every specified region, a stacked-layer film made up of a gate electrode, the gate insulating film, and a semiconductor layer each having a same shape as the gate electrode, and a scanning line and a terminal portion lower layer metal film;

a process of forming a signal line after having formed a protective film on an entire surface of the transparent insulating substrate;

a process of forming a first insulating film on an entire surface of the transparent insulating substrate and forming convex and concave portions in a display region;

a process of forming a second insulating film on an entire surface of the transparent insulating substrate and forming contact holes in places facing each other on the semiconductor layer and in the second insulating film on a signal line existing in a vicinity and, at a same time, of removing at least the second insulating film on the terminal portion lower layer metal film;

a process of forming contact holes in places facing each other on the semiconductor layer and in the protective film on the terminal portion lower layer metal film;

a process of doping the semiconductor layer with an element having a valence of V through the contact hole formed in the protective film to form a source region and a drain region; and

a process of integrally forming a source electrode and a reflective electrode to be connected to the source region and a drain electrode to be connected to the drain region, and a connecting electrode connecting the drain electrode to the signal line, all of which are made up of both a metal having a high melting point and an alloy mainly containing Al being formed and stacked in a layer on the metal having a high melting point.

According to a fourth aspect of the present invention, there is provided a method for manufacturing an LCD including:

a step of sequentially forming a metal layer, a gate insulating film, and a semiconductor layer, in this order, on a transparent insulating substrate and then forming, by using a photoresist having a plurality of regions each having a different thickness which has been formed by changing an integration value of an amount of exposure for every specified region, a stacked-layer film made up of a gate electrode, the gate insulating film, and a semiconductor layer each having a same shape as the gate electrode, and a scanning line and a terminal portion lower layer metal film;

a process of forming a signal line after having formed a protective film on an entire surface of the transparent insulating substrate;

a process of forming a first insulating film on an entire surface of the transparent insulating substrate and forming convex and concave portions in a display region;

a process of forming a second insulating film on an entire surface of the transparent insulating substrate and forming contact holes in places facing each other on the semiconductor layer and in the second insulating film on a signal line existing in a vicinity and, at a same time, of removing at least the second insulating film on the terminal portion lower layer metal film;

a process of forming a pixel electrode made up of a transparent conductive film;

a process of forming Contact holes in places facing each other on the semiconductor layer and in the protective film on the terminal portion lower layer metal film;

a process of doping the semiconductor layer with an element having a valence of v through the contact hole formed in the protective film to form a source region and a drain region; and

a process of integrally forming a source electrode to be connected to the source region and a reflective electrode to be connected to the pixel electrode, a drain electrode to be connected to the drain region, and a connecting electrode connecting the drain electrode to the signal line, all of which are made up of both a metal having a high melting point and an alloy mainly containing Al being formed and stacked in a layer on the metal having a high melting point.

According to a fifth aspect of the present invention, there is provided a method for manufacturing an LCD including:

a process of forming a gate electrode, a scanning line, and a terminal portion lower layer metal film on a transparent insulating substrate;

a process of sequentially forming a gate insulating film, a semiconductor layer, and a metal layer, in this order, on the transparent insulating substrate and then forming, by using a photoresist having a plurality of regions each having a different thickness which has been formed by changing an integration value of an amount of exposure for every specified region, a semiconductor layer after having formed a source electrode, a drain electrode, and a signal line;

a process of forming a passivation film on an entire surface of the transparent insulating substrate and then a first insulating film and forming convex and concave portions in a display region;

a process of forming a second insulating film on an entire surface of the transparent insulating substrate and forming contact holes in the second insulating film on the source electrode and, at a same time, of removing at least the second insulating film on the terminal portion lower layer metal film;

a process of forming contact holes in the passivation film over the source electrode and the terminal portion lower layer metal film; and

a process of forming a reflective electrode to be connected to the source electrode made up of an alloy mainly containing Al or of both a metal having a high melting point and an alloy mainly containing Al being formed and stacked on the metal having a high melting point.

According to a sixth aspect of the present invention, there is provided a method for manufacturing an LCD including:

a process of forming a gate electrode, a scanning line, and a terminal portion lower layer metal film on a transparent insulating substrate;

a process of sequentially forming a gate insulating film, a semiconductor layer, and a metal layer, in this order, and then forming, by using a photoxesist having a plurality of regions each having a different thickness which has been formed by changing an integration value of an amount of exposure for every specified region, a semiconductor layer after having formed a source electrode, a drain electrode, and a signal line;

a process of forming a passivation film on an entire surface of the transparent insulating substrate and then a first insulating film and then forming convex and concave portions in a display region;

a process of forming a second insulating film on an entire surface of the transparent insulating substrate and forming contact holes in the second insulating film over the source electrode and, at a same time, of removing at least the second insulating film on the terminal portion lower layer metal film;

a process of forming a pixel electrode made up of a transparent conductive film;

a process of forming contact holes in the source electrode and in the passivation film over the terminal portion lower layer metal film; and

a process of forming the source electrode and the reflective electrode to be connected to the reflective electrode both being made up of both a metal having a high melting point and an alloy mainly containing Al being formed and stacked in a layer on the metal having a high melting point.

In the foregoing, a preferable mode is one that wherein includes a process of simultaneously forming both the terminal portion connecting electrode being formed on a terminal portion and being connected to the terminal portion lower metal film and the reflective electrode.

Also, a preferable mode is one that wherein further includes a process of simultaneously forming both the terminal portion connecting electrode being formed on a terminal portion and being connected to the terminal portion lower metal film and the pixel electrode.

Also, a preferable mode is one that wherein further includes:

a process of forming a gate electrode, a scanning line, and a terminal portion lower layer metal film on a transparent insulating substrate;

a process of sequentially forming a gate insulating film, a semiconductor layer, and a metal layer in this order on the transparent insulating substrate and forming, by using a photoresist having a plurality of regions each having a different thickness which has been formed by changing an integration value of an amount of exposure for every specified region, a source electrode and a drain electrode after having formed a signal line and the semiconductor layer;

a process of forming a passivation film on an entire surface of the transparent insulating substrate and then a first insulating film on the passivation film and forming convex and concave portions in a display region;

a process of forming a second insulating film on an entire surface of the transparent insulating substrate and forming contact holes in the second insulating film on the source electrode and, at a same time, of removing at least the second insulating film on the terminal portion lower layer metal film;

a process of forming contact holes in the source electrode and in the passivation film over the terminal portion lower layer metal film; and

a process of simultaneously forming a reflective electrode to be connected to the source electrode and the terminal portion connecting electrode to be connected to the terminal portion lower layer metal film both being made up of an alloy mainly containing Al or a metal having a high melting point and an alloy mainly containing Al being formed and stacked on the metal having a high melting point.

Also, a preferable mode is one that wherein includes:

a process of forming a gate electrode, a scanning line, and a terminal portion lower layer metal film on a transparent insulating substrate;

a process of sequentially forming a gate insulating film, a semiconductor layer, and a metal layer in this order on the transparent insulating substrate and forming, by using a photoresist having a plurality of regions each having a different thickness which has been formed by changing an integration value of an amount of exposure for every specified region, a source electrode and a drain electrode after having formed a signal line and a semiconductor layer;

a process of forming a passivation film on an entire surface of the transparent insulating substrate and then a first insulating film and forming convex and concave portions in a display region;

a process of forming a second insulating film on an entire surface of the transparent insulating substrate and forming contact holes in the second insulating film on the source electrode and, at a same time, of removing at least the second insulating film on the terminal portion lower layer metal film;

a process of forming a pixel electrode made up of a transparent conductive film;

a process of forming contact holes in the source electrode and in the passivation film on the terminal portion lower layer metal film; and

a process of forming a reflective electrode to be connected to the source electrode and to the pixel electrode and the terminal portion connecting electrode to be connected to the terminal portion lower layer metal film both being made up of both a metal having a high melting point and an alloy mainly containing Al being formed and stacked in a layer on the metal having a high melting point.

Also, a preferable mode is one wherein, in the processes to forming the first insulating film or the second insulating film, both the process of forming convex and concave portions in the first insulating film and the process of forming contact holes in the second insulating film are simultaneously performed by changing an integration value of an amount of exposure for every specified region.

Also, a preferable mode is one wherein both the process of forming contact holes in the first insulating film or the second insulating film and the process of forming the contact holes in the passivation film or in the protective film are performed by one time etching.

According to a seventh aspect of the present invention, there is provided a liquid crystal display serving as a reflective-type liquid crystal display having a reflective electrode being formed on one substrate out of a pair of substrates being placed in such a manner to face each other with a liquid crystal layer being interposed between the pair of the substrates and operating to reflect incident light emitted from an other substrate on which the reflective electrode is not formed, wherein the reflective electrode and a terminal portion connecting electrode being formed at a terminal portion are made up of an alloy mainly containing Al being excellent in pitting corrosion or of both a metal having a high melting point and an alloy mainly containing Al being excellent in pitting corrosion and being formed and stacked in a layer on the alloy having a high melting point.

According to an eighth aspect of the present invention, there is provided a method for manufacturing an LCD serving as a semi-transmissive reflective-type LCD having a reflective electrode being formed on one substrate out of a pair of substrates being placed in such a manner to face each other with a liquid crystal layer being interposed between the pair of the substrates and operating to reflect incident light emitted from an other substrate on which the reflective electrode is not formed and having a pixel electrode through which incident light entered from a side of the one substrate passes, wherein both the reflective electrode and a terminal portion connecting electrode being formed on a terminal portion are made up of a metal having a high melting point and an alloy mainly containing Al being excellent in pitting corrosion and being formed and stacked in a layer on the alloy having a high melting point.

In the foregoing, a preferable mode is one wherein an element or elements to be added to the alloy containing mainly Al include any one of Nd, Ti, Cr, and Ta, or at least one group selected from groups consisting essentially of a plurality of elements including Nd, Ti, Cr, and Ta.

Also, a preferable mode is one wherein the alloy contains 2% or more, in a total amount, of the elements to be added to the alloy.

Furthermore, a preferable mode is one wherein the alloy contains 0.9% or more by atom of Nd.

With the above configuration, in the semi-transparent reflective-type LCD in particular, since the reflective electrode and terminal portion connecting electrode are simultaneously formed using an alloy mainly containing Al having corrosion resistance, more particularly, Al—Nd alloy as a material for both the reflective electrode and terminal portion connecting electrode, a process of manufacturing a TFT is shortened and reliability of the LCD operation can be maintained.

### BRIEF DESCRIPTION OF THE DRAWINGS

The above and other objects, advantages, and features of the present invention will be more apparent from the following description taken in conjunction with the accompanying drawings in which:

FIG. 1 is a plan view of configurations conceptually illustrating a TFT substrate of a reflective-type LCD according to a first embodiment of the present invention;

FIG. 2 is a plan view of a panel of the reflective-type LCD according to the first embodiment of the present invention;

FIG. 3 is a cross-sectional view of a panel, taken along lines A-A, B-B of FIG. 2;

FIG. 4 is a plan view of a configuration of one pixel portion on a TFT substrate of the reflective-type LCD according to the first embodiment of the present invention;

FIGS. 5A, 5B, 5C, and 5D are cross-sectional views of one pixel portion of FIG. 4, taken along a line B-B according to the first embodiment of the present invention;

FIGS. 6E, 6F, 6G, 6H are cross-sectional views of one pixel portion of FIG. 4, taken along the line B-B according to the first embodiment of the present invention;

FIGS. 7A, 7B, 7C, 7D, and 7E are cross-sectional views illustrating processes employed in a method for manufacturing a terminal section of a reflective-type LCD according to the first embodiment of the present invention;

FIGS. 8A, 8B, 8C, 8D, 8E, and 8F are cross-sectional views illustrating processes in a method of manufacturing a layer converting portion of a signal line of a signal line drawing wiring according to the first embodiment of the present invention;

FIG. 9 is a plan view illustrating a configuration of one pixel portion on a TFT substrate of a reflective-type LCD of a second embodiment of the present invention;

FIGS. 10A, 10B, 10C, and 10D are cross-sectional views of processes employed in a method of manufacturing the TFT substrate of the reflective-type LCD, taken along a line B-B of FIG. 9;

FIGS. 11E and 11F are also cross-sectional views of processes employed in the method of manufacturing the TFT substrate of the reflective-type LCD, taken along a line B-B of FIG. 9;

FIGS. 12A, 12B, 12C, 12D, and 12E are cross-sectional views illustrating processes employed in the method for the TFT substrate of the reflective-type LCD of the second embodiment of the present invention;

FIG. 13 is a plan view of a configuration of one pixel portion on a TFT substrate of a reflective-type LCD according to a third embodiment of the present invention;

FIGS. 14A, 14B, 14C, 14D, and 14E are cross-sectional views of processes employed in a method of manufacturing the TFT substrate of the reflective-type LCD, taken along a line B-B of FIG. 13;

FIGS. 15F and 15G are cross-sectional views of processes employed in a method of manufacturing the TFT substrate of the reflective-type LCD, taken along the line B-B of FIG. 13;

FIGS. 16A, 16B, 16C, 16D, and 16E are cross-sectional views explaining processes employed in FIGS. 14B and 14C;

FIGS. 17 is a plan view of a configuration of one pixel portion on a TFT substrate of a reflective-type LCD according to a fourth embodiment of the present invention;

FIGS. 18A, 18B, 18C, 18D, and 18E are cross-sectional views of processes employed in a method of manufacturing the TFT substrate of the reflective-type LCD, taken along a line B-B of FIG. 17;

FIGS. 19F and 19G are cross-sectional views of processes employed in the method of manufacturing the TFT substrate of the reflective-type LCD, taken along the line B-B of FIG. 17;

FIGS. 20A, 20B, 20C, 20D, and 20E are cross-sectional views explaining processes employed in FIGS. 18B and 18C;

FIG. 21 is a plan view of a configuration of one pixel portion on a TFT substrate of a semi-transparent reflective-type LCD according to a fifth embodiment of the present invention;

FIGS. 22A, 22B, 22C, 22D, 22E, and 22F are cross-sectional views of processes employed in a method of manufacturing the TPT substrate of the semi-transparent reflective-type LCD, taken along a line B-B of FIG. 21;

FIGS. 23G, 23H, and 23I are cross-sectional views of processes employed in the method of manufacturing the TFT substrate of the semi-transparent reflective-type LCD, taken along the line B-B of FIG. 21;

FIG. 24 is a plan view of configurations of one pixel portion on a TFT substrate of a semi-transparent reflective-type LCD according to a sixth embodiment of the present invention;

FIGS. 25A, 25B, 25C, and 25D are cross-sectional views of processes employed in a method of manufacturing the TFT substrate of the semi-transparent reflective-type LCD, taken along a line B-B of FIG. 24;

FIGS. 26E, 26F and 26G are cross-sectional views of processes employed in the method of manufacturing the TFT substrate of the semi-transparent reflective-type LCD, taken along the line B-B of FIG. 24;

FIG. 27 is a plan view of configurations of one pixel portion on a TFT substrate of a semi-transparent reflective-type LCD according to a seventh embodiment of the present invention;

FIGS. 28A, 28B, 28C, 28D, 28E are cross-sectional views of processes employed in a method of manufacturing the TFT substrate of the semi-transparent reflective-type LCD, taken along a line B-B of FIG. 27;

FIGS. 29F, 29G and 26H are cross-sectional views of processes employed in the method of manufacturing the TFT substrate of the semi-transparent reflective-type LCD, taken along the line B-B of FIG. 27;

FIG. 30 is a planview of configurations of one pixel portion on a TFT substrate of a semi-transparent reflective-type LCD according to an eighth embodiment of the present invention;

FIGS. 31A, 31B, 31C, 31D, and 31E are cross-sectional views of processes employed in a method of manufacturing the TFT substrate of the semi-transparent reflective-type LCD, taken along a line B-B of FIG. 30;

FIGS. 32F, 32G and 32H are cross-sectional views of processes employed in the method of manufacturing the TFT substrate of the semi-transparent reflective-type LCD, taken along the line B-B of FIG. 30;

FIG. 33 is a cross-sectional view showing one pixel portion of the TFT substrate of the reflective-type LCD to be manufactured by a modified method in the second embodiment and of the TFT, taken along a line B-B of FIG. 9;

FIG. 34 is a cross-sectional view showing one pixel portion of the TFT substrate of the reflective-type LCD to be manufactured by a modified method in the third and fourth embodiments and of the TFT, taken along the line B-B of FIGS. 13 and 17;

FIG. 35 is a cross-sectional view showing one pixel portion of the TFT substrate of the semi-transparent reflective-type LCD to be manufactured by a modified method in the sixth embodiment and of the TFT, taken along a line B-B of FIG. 24;

FIG. 36 is a cross-sectional view showing one pixel portion of the TFT substrate of the reflective-type LCD to be manufactured by a modified method in the seventh and eighth embodiments and of the TFT, taken along the lines B-B of FIG. 27 and 30;

FIG. 37 is a graph showing a time-varying change in pitting corrosion density of pure Al and various Al alloys employed in the present invention;

FIG. 38 is a graph showing a time-varying change in pitting corrosion density of a Al—Nd alloy film and Al—Ti alloy film employed in the present invention;

FIG. 39 is a plan view of aconfiguration of one pixel portion of a TFT of a conventional reflective-type LCD; and

FIGS. 40A to 40K are a cross-sectional view showing a method of manufacturing the TFT of the conventional reflective-type LCD.

### DETAILED DESCRIPTION OF THE PREFERRED EMBODIMENTS

Best modes of carrying out the present invention will be described in further detail using various embodiments with reference to the accompanying drawings. In the following drawings, same reference numbers are assigned to corresponding parts having the same functions in other drawings.

First Embodiment

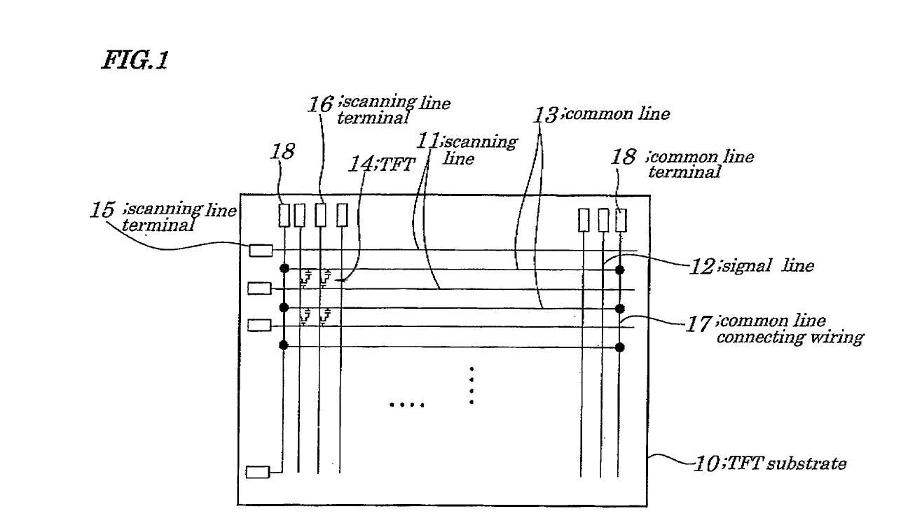

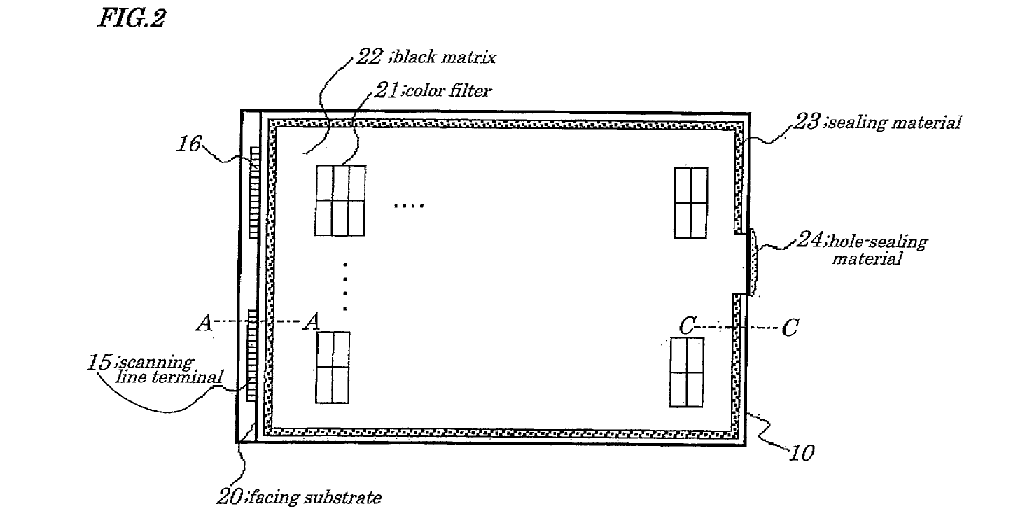

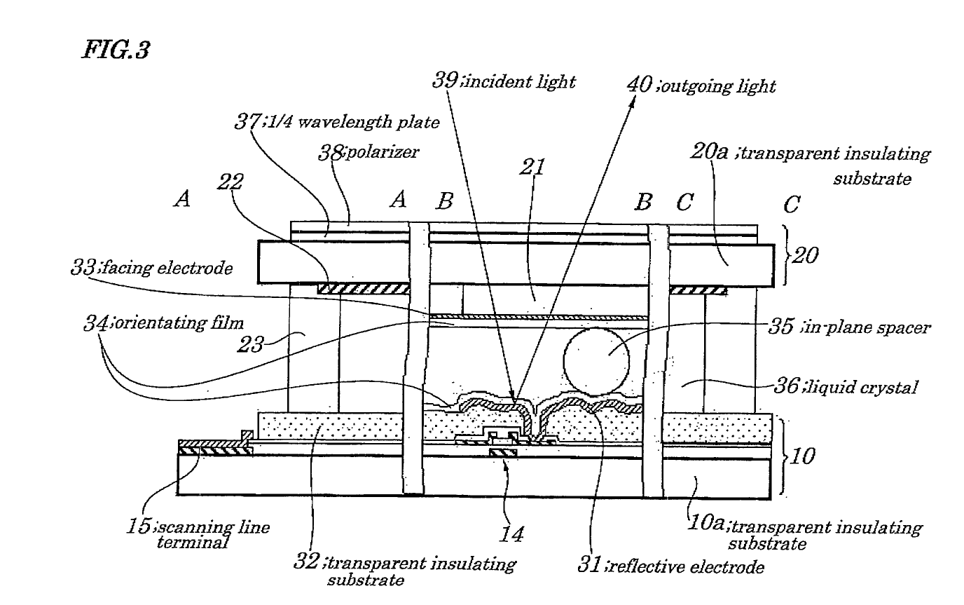

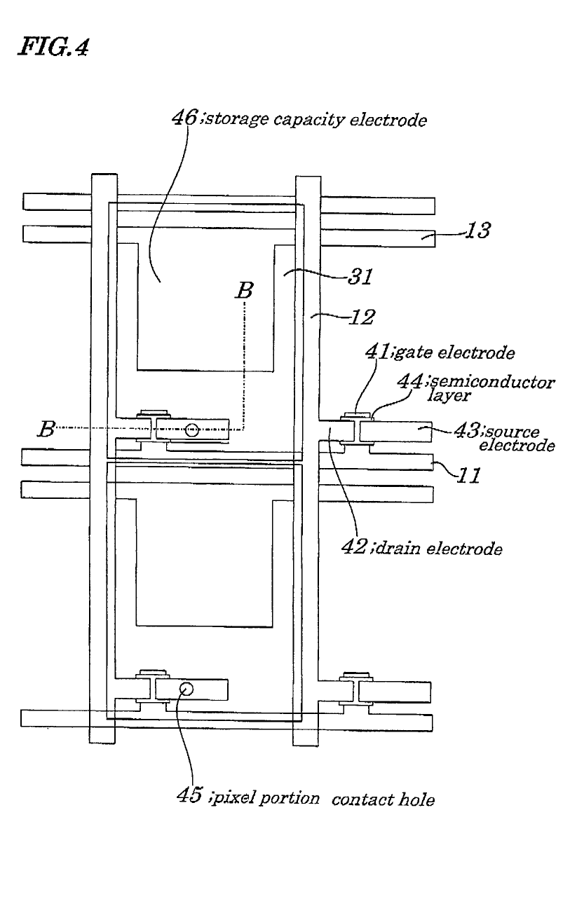

FIG. 1 is a plan view of configurations illustrating a TFT substrate 10 of a reflective-type LCD according to a first embodiment of the present invention. FIG. 2 is a plan view of a panel of the reflective-type LCD according to the first embodiment. FIG. 3 is a cross-sectional view of a panel, taken along lines A-A, B-B (corresponding to a cross-sectional view of the TFT, taken along a line B-B of FIG. 4), and C-C of FIG. 2.

In a TFT substrate 10, as shown in FIGS. 1 and 3, on a transparent insulating substrate 10a are placed a plurality of scanning lines 11 and a plurality of signal lines 12 in such a manner that each of the plurality of scanning lines 11 and each of the plurality of signal lines 12 intersect each other at right angles and in a vicinity of a point of intersection is mounted each of TFTs 14 serving as a switching element in a matrix form. Moreover, each of a plurality of common lines 13 is placed in parallel with each of the plurality of scanning lines and a holding capacity is produced between each of the common lines and each of reflective electrodes being connected to the TFT 14. The reflective electrode 31 adapted to apply a voltage to a liquid crystal is placed on an organic interlayer insulating film 32 which separates the reflective electrode 31 from each of the scanning line 11, signal line 12 and the TFT 14. Concave and convex portions are formed on the organic interlayer insulating film 32 which also causes concave and convex portions to be formed on the reflective electrode 31. At an end of each of the scanning lines 11 is connected a scanning line terminal 15 used to input an address signal and at an end of each of the signal lines 12 is connected a signal line terminal 16 used to input a data signal. Moreover, the common lines 13 are connected to each other through a common line connecting wiring 17, in ordinary cases, at both sides of the TFT substrate 10 and at an end of each of the common line connecting wiring 17 is connected each of common line terminal 18 being supplied with a same potential as that of a facing electrode 33 on a facing substrate 20. In the example, each of the scanning lines 15 and each of the signal line terminals 16 are conceptually shown so as to occupy one side of the TFT substrate 10, however, since the reflective-type LCD is designed to be used for small-sized portable devices, each of the scanning lines 15 and each of the signal line terminals 16 are placed in a manner that both of them are put together on one side of the TFT substrate 10 (see FIG. 2).

On the other hand, as shown in FIGS. 2 and 3, on the facing substrate 20, a color filter 21 corresponding to a display region and facing electrode 33 used to apply a voltage to a liquid crystal are placed on a transparent insulating substrate 20a and in a surrounding portion is placed a black matrix 22. Since the reflective electrode 31 also serves as a light-shielding layer, no black matrix is placed in the display region. The black matrix 22 is used to enhance an appearance of the reflective-type LCD.

Orientating films 34 for arranging direction of orientation of a molecule of the liquid crystal are placed on surfaces of the TFT substrate 10 and the facing substrate 20 being opposite to each other. The facing substrate 20 is overlaid on the TFT substrate 10 with a sealing material 23 and an in-plane spacer 35 being interposed between the facing substrate 20 and the TFT substrate 10 providing a specified clearance and a liquid crystal 36 is sandwiched between the orientating films 34. A space portion, in which the liquid crystal 36 is injected, being surrounded by a sealing member is closed by a hole-sealing material 24 in a hermetically sealed manner. On a surface on an opposite side facing the TFT substrate 10 of the facing substrate 20 are placed a ¼ wavelength plate 37 and a polarizer 38, which serve as a panel for liquid crystal display. Though not shown in FIG. 2, an IC chip operating as an driving circuit at portions of the scanning line terminal 15 and the signal line terminal 16 is packaged with COG (Chip-On-Glass) technology to finish the LCD.

As shown in FIG. 3, incident light 39 entered from a rear side of the facing substrate 20 transmits through the facing substrate 20 and liquid crystal layer 36 and is reflected off the concave and convex portions existing on the reflective electrode 31 on a surface of the TFT substrate 10 and again transmits through the liquid crystal layer 36 and the facing substrate 20 and is emitted as outgoing light 40.

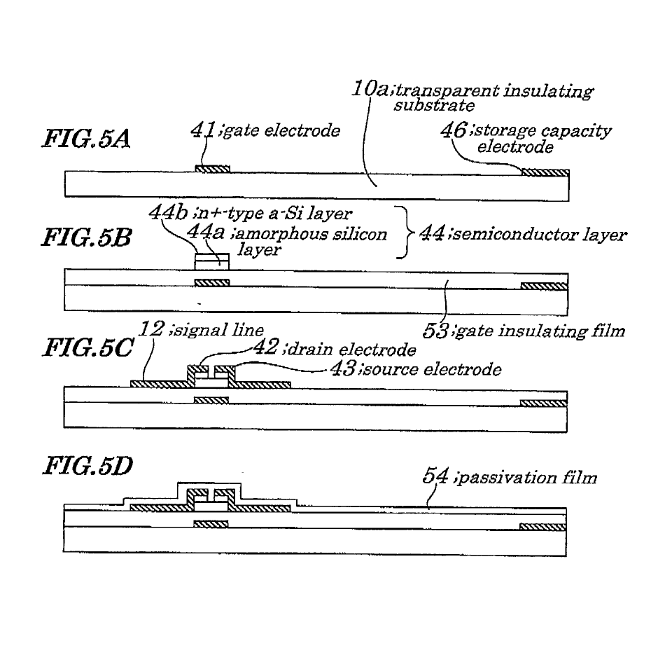

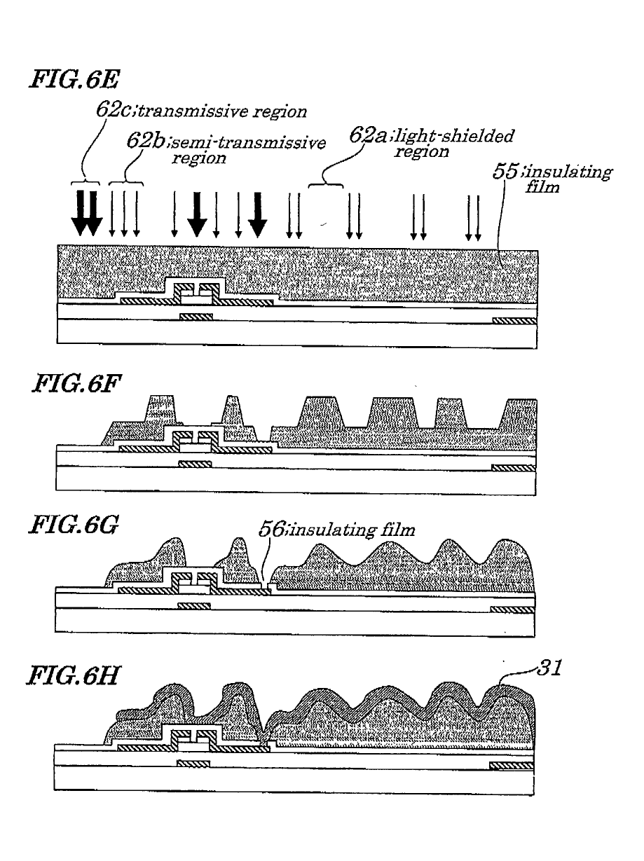

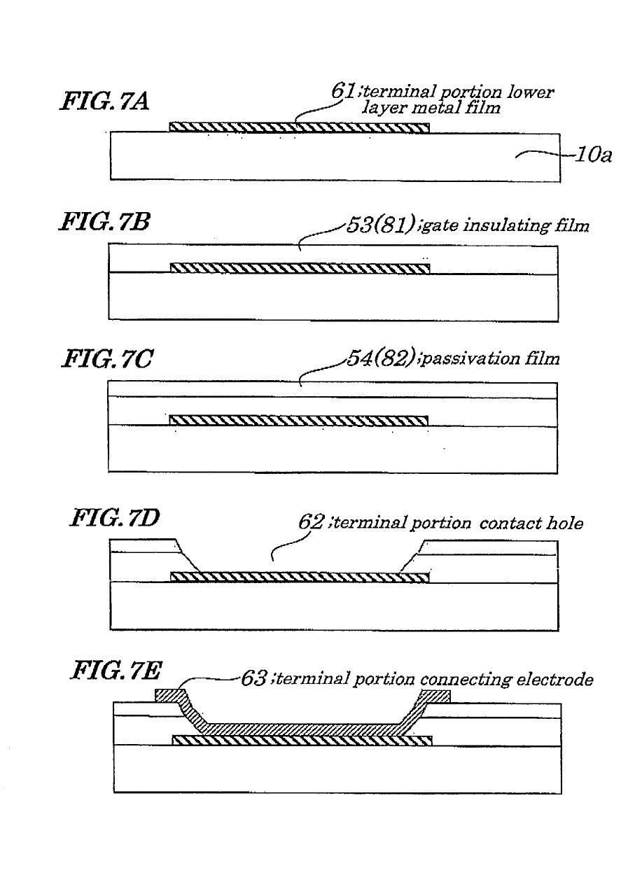

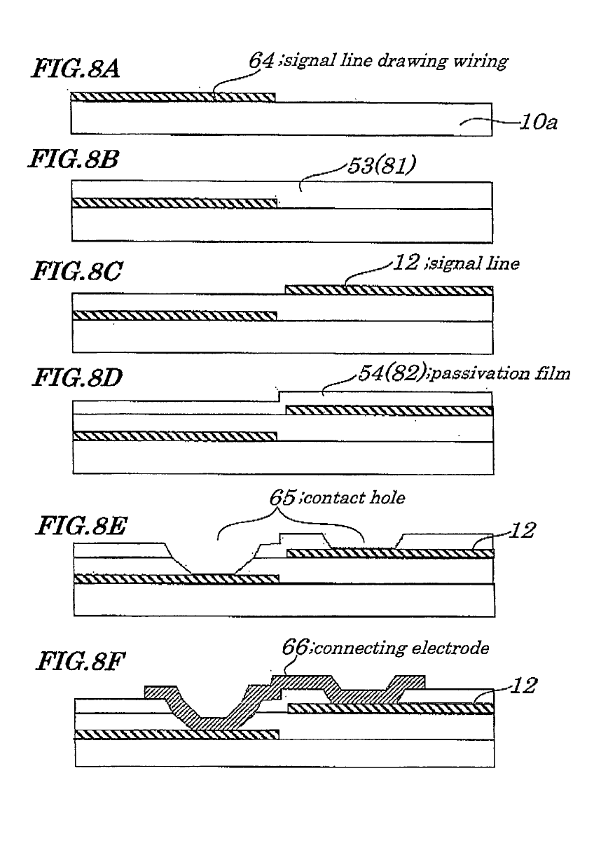

Next, configurations of the TFT substrate 10 of the reflective-type LCD according to the first embodiment of the present invention and its manufacturing method will be described in detail by referring to FIG. 4 to FIG. 7A. FIG. 4 is a plan view of a configuration of one pixel portion on the TFT substrate 10 of the reflective-type LCD according to the first embodiment. FIGS. 5A to 5D are cross-sectional views of one pixel portion of FIG. 4, taken along a line B-B according to the first embodiment. FIGS. 6E to 6H are cross-sectional views of one pixel portion of FIG. 4, taken along the line B-B according to the first embodiment. In the embodiment, an inverted staggered channel etching-type TFT is used as a switching element which corresponds to a pixel portion existing on a most outside surrounding portion on a leftmost side in FIG. 1. FIGS. 7A to 7E are cross-sectional views of the scanning line terminal 15, the signal line terminal 16 and the common line terminal 18 in a direction of a short side. FIGS. 8A to 8F are cross-sectional views illustrating the signal line 12 and the signal line drawing wiring 64 of the first embodiment.

As shown in FIG. 4 and FIG. 6H, one pixel portion of the TFT substrate 10 of the reflective-type LCD of the first embodiment includes the scanning line 11 and the signal line 12 which intersect each other at right angles, the TFT 14 being a switching element mounted in each of pixel regions, the reflective electrode 31 which reflects light entering each of the pixel regions and applies voltage to the liquid crystal 36 being sandwiched between the TFT substrate 10 and the facing substrate 20, the insulating film 55 which contains an insulating film 55 used to form specified concave and convex portions at the reflective electrode 31, in which a gate electrode 41 is connected to the scanning line 11, a drain electrode 42 is connected to the signal line 12, a source electrode 43 is connected to the reflective electrode 31, and a storage capacity electrode 46 is connected to the common line 13, The storage capacity between the storage capacity electrode 46 and the reflective electrode 31 is produced, Moreover, since the reflective electrode 31 functions as a pixel electrode that applies a voltage to the liquid crystal, separation of each reflective electrode 31 for every pixel is required and, as a result, the reflective electrode 31 is separated on the scanning line 11 and signal line 12 for every pixel.

Furthermore, as shown in FIGS. 5A to 5D, on a side of the TFT substrate 10, the gate electrode 41 is formed in the TFT region existing on a transparent insulating substrate 10a on which a semiconductor layer 44, which is made up of a-Si (amorphous silicon layer) layer 44a and n⁺-type a-Si layer 44b, is formed with a gate insulating film being interposed between the semiconductor layer 44 and the gate electrode 41, and the drain electrode 42 and the source electrode 43 are formed on the n⁺-type a-Si layer 44b. In each of the pixel regions is integrally formed the insulating film 55 used to form specified convex and concave portions on the reflective electrode 31 in an irregular and gentle manner.

Since the insulating film 55 provides a reflection optical characteristic uniformly over all surfaces of the display region, it is formed integrally within the display region and since a portion outside the display region (region on a left side in FIG. 4) is used to mount a terminal electrode or alike, no insulating film 55 is formed. Then, the reflective electrode 31 is formed on the insulating film 55 formed on a passivation film 54 used to protect the TFT 14, and the reflective electrode 31 is connected to the source electrode 43 in a pixel portion contact hole 45 mounted on the source electrode 43.

The convex and concave portions formed on the insulating film 55 exerts an influence on a shape of a surface of the reflective electrode 31 and an angle of a slant formed by the convex and concave portions on the surface of the reflective electrode 31 determines an optical characteristic of reflective light. Therefore, the angle of the slant is provided so as to obtain a desired reflective optical characteristic. Moreover, at this time, only a thing that is needed is that each of a convex pitch, concave pitch, convex height, and concave depth has different values of two kinds or more.

Moreover, a lower limit of a film thickness of the insulating film 55 is defined by the reflective optical characteristic and receives a limitation from a standpoint of parasitic capacity. That is, if the insulating film 55 is formed in a manner that its thickness is small, since a great change in a direction of reflection of incident light is made impossible and since a clearance among the reflective electrode 31, scanning line 11 and signal line 12 becomes narrow, parasitic capacitance occurring among the reflective electrode 31, scanning line 11 and signal line 12 becomes large which causes a delay in signal transmission and makes it impossible to transmit a signal correctly and an electric field between the signal line and the pixel becomes stronger which affects a liquid crystal existing in the vicinity and causes a disturbance in direction of orientation of a molecule and causes a delay and, as a result, display quality is impaired. To solve this problem, the insulating film 55 is formed so that its thickness is about 1.5 μm to 4 μm.

As shown in FIG. 5A to FIG. 6H, FIGS. 7A to 7E and FIGS. 8A to 8F, the manufacturing method roughly include (1) a process of forming a metal film for the gate electrode 41 and of performing patterning on the metal film of the gate electrode 42, (2) a process of forming the gate insulating film 53, a-Si layer 44a, and n⁺-type a-Si layer 44b and of performing patterning on them, (3) a process of forming a metal film for the drain electrode 42 and source electrode 43, and of performing patterning on them, (4) a process of forming the passivation film 54 and insulating film 55, of performing patterning on the insulating film 55 and of changing a surface shape of the insulating film 55, (5) a process of performing patterning on the passivation film 54, and (6) a process of forming a metal film for the reflective electrode 31 and of performing patterning on the metal film of the reflective electrode 31.

First, on a transparent insulating substrate 10a made of a non-alkaline glass having a thickness of 0.5 mm is formed a first metal film having a thickness of 100 nm to 300 nm made of Cr (chromium) or a like by sputtering and, then by well-known photolithography and etching processes, the gate electrode 41, the scanning line 11 (not shown), the common line 13 (not shown), the storage capacity electrode 46, the scanning line terminal 15, the signal line terminal 16, a terminal portion lower layer metal film 61 of the common line terminals 18 and a signal line drawing wiring 64 (FIG. 1, FIG. 5A, FIG. 7A and FIG. 8A) . Moreover, as a material for the above lines or wirings, not only Cr but also a wiring film of a stacked layer structure obtained by forming a barrier metal made of Cr, Mo, Ti, or a like, on a Mo, Al or an Al alloy, having a low resistance and allowing patterning easily to be performed by thin-film formation technology and photolithography can be employed.

Next, after the gate insulating film 53 made up of SiN (silicon nitride) having a thickness of 300 nm to 500 nm using a plasma CVD (Chemical Vapor Deposition) method has been formed and then a non-doped a-Si (amorphous silicon) having a thickness of 150 nm to 500 nm and a doped silicon (n⁺-type a-Si) having a thickness of 30 nm to 50 nm also using the plasma CVD method have been formed, the semiconductor layer 44 made up of the a-Si layer 44a and n⁺-type a-Si layer 44b is formed by photolithography and patterning processes (FIG. 5B, FIG. 7B, and FIG. 8B). Here, the a-Si layer 44a serves as an active layer of the TFT 14 and the n⁺-type a-Si layer 44b is used to ensure ohmic contact among the drain electrode 42, source electrode 43 and a-Si layer 44a.

Next, by sputtering Cr or a like, a second metal film having a thickness of 100 nm to 300 nm is formed and then by performing patterning using photolithography, the drain electrode 42, the source electrode 43 and the signal line 12 are formed. Then, by performing dry etching using the drain electrode 42 and the source electrode 43 as masks, the n⁺-type a-Si layer 44b existing between the drain electrode 42 and the source electrode 43 is removed (FIG. 5C, FIG. 7B, and FIG. 8C). The aim of removing the n⁺-type a-Si layer 44b is to prevent a current from directly flowing through the n⁺-type a-Si layer 44b between the drain electrode 42 and the source electrode 43. Moreover, as a material for the above line or wiring, not only Cr but also a wiring film of a stacked structure obtained by forming a barrier metal made of Cr, Mo, Ti or a like, on or under Mo, Al or an Al alloy, having a low resistance and allowing patterning easily to be performed by thin-film formation technology and photolithography, can be employed. To perform etching the n⁺-type a-Si layer 44b, a photoresist being used when the drain electrode 42 and the source electrode 43 are formed may be used as a mask.

Next, silicon nitride having a thickness of 100 nm to 300 nm is formed by using the plasma CVD method and then the passivation film 54 is formed (FIG. 5D, FIG. 7C, and FIG. 7D)

Next, a coat of the insulating film 55 made up of a photosensitive novolak resin having a thickness of 2 μm to 4μm is put on all the surface of the passivation film 54. Then, convex and concave portions are formed by performing exposure and development on the insulating film 55. In the embodiment, as a photomask, a half tone mask is used, which has a transmissive region allowing light for exposure to pass through, a semi-transmissive region allowing light for exposure being attenuated by a specified amount to pass through, and light-shielded region. That is, positioning is made so that a region 62a having the convex portion corresponds to the light-shielded region, a region 62b having the concave portion corresponds to the semi-transmissive region, and a region 62c in which the insulating film 55 is completely removed corresponds to the transmissive region, and then exposure is performed (FIG. 6E).

Next, by performing development, in the light-shield region, the insulating film 55 is left as it is and, in the semi-transmissive region, since the insulating film 55 is etched to some extent, specified convex and concave portions are formed in the insulating film 55. Moreover, in a region adjacent to a region (that is, transmissive region 62c) in which the insulating film 55 is completely removed is provided a region (that is, semi-transmissive region 62b) in which some films are always left so that the insulating film 55 causes a sharp step to be produced.

Thus, by employing the half tone mask in the exposure processes so as to provide the region in which the insulating film 55 is completely removed by performing exposure for a long time or by applying strong light to make the insulating film 55 be completely exposed in the development and, the region in which some regions are left by performing exposure for a short time or by applying weak light and the region in which no light is applied and therefore no insulating film 55 is removed, it is made possible to reduce the number of times of photo-processes by one.

In the embodiment, as the insulating film 55, a novolak organic resin is used. For example, “PC403” manufactured by JSR (Japanese company) or a like may be employed. Moreover, it is possible to form a desired convex and concave made up of not only the novolak resin but also organic resins such as an acrylic resin, polyimide resin, or a like, or non-organic resins such as a silicon nitride resin, silicon oxide resin, or a like. Also, as the material for the insulating film 55, either of resins having no photosensitivity or resins having photosensitivity may be employed. The processes in which the resin having no photosensitivity is used includes (1) a process of putting a coat of the insulating film 55 on the substrate, (2) a process of putting a coat of a resist to be used for patterning on the insulating film 55, (3) a process of performing exposure, (4) a process of performing development, (5) aprocess of etching on the insulating film 55, and (6) a process of peeling the resist. On the other hand, the processes in which the resin having no photosensitivity is used includes (1) a process of putting a coat of the insulating film 55 on the substrate, (2) a process of performing exposure, (3) a process of performing development. As a result, processes of forming and peeling off a resist film can be omitted which is favorable from a standpoint of decrease of the number of processes. Moreover, an example in which coating with the insulating film 55 is performed is shown, however, instead of the coating process, printing process may be employed (FIG. 6F).

Next, a process of changing a shape of a surface of the insulating film is performed. In this process, a surface of the insulating film 55 having undergone the patterning is melt by performing heat treatment at a temperature of 80° C. to 200° C. and is changed so as to have a smooth shape of the surface of the insulating film 55. Moreover, in the process of changing a shape of a surface of the insulating film 55, instead of using thermal processing, for example, a melting method by using a chemical or a like may be employed. After the process of changing a shape of a surface of the insulating film 55 has been performed, burning process at a temperature of about 200° C. to 250° C. is again performed.

Next, by performing patterning, using photolithography, on the passivation film 54 formed on the source electrode 43, terminal portions of the signal line 12 on the gate insulating film 53 and on the passivation film 54 formed on the scanning line terminal 15 (not shown), the terminal portion lower layer metal film 61 of the common line terminal 18, and the signal line drawing wiring 64, and the gate insulating film 53, contact holes 56, 62 and 65 are formed (FIG. 6G, FIG. 7D, and FIG. 8E) . The passivation film 54 is used to prevent impurities such as ions or a like from being diffused in the a-Si layer 44a and an operational failure in the TFT14 from occurring.

Next, an Al—Nd alloy film having a thickness of 100 nm to 300 nm is formed by using a sputtering method and, by performing patterning using photolithography, the reflective electrode 31, terminal portion connecting electrode 63, and connecting electrode 66 are formed to finish the TFT substrate (FIG. 6H, FIG. 7E, and FIG. 8F). Preferably, the Al—Nd alloy contains 0.9% or more by atom of Nd (0.9 atom %) . The reason is that it serves to inhibit corrosion (pitting corrosion) of the terminal portion connecting electrode 63 and to improve reliability in connection. As an element that can be added to the Al alloy mainly containing Al, besides Nd, any one of Ti, Cr, Ta, or at least two elements selected from a group consisting essentially of Nd, Ti, Cr, and Ta may be used and, in this case, it is preferable that total contents are 2% or more by atom (2 atom %) (described later in detail). Moreover, the reflective electrode 31 and each of the connecting electrodes 66 may be formed by using not only a single layer film but also a layer obtained by stacking the Al alloy film on a metal film having a high melting point such Cr or Mo. In this case, the film having a high melting point performs a function of enhancing adhesion between the insulating film 55 and the Al alloy film.

In the embodiment, the method in which the concave and convex portions are formed by a half-tone mask is employed, however, instead of the method of using the half stone, a method in which the same convex or concave portions as described above are formed by changing an amount of exposure using different two masks, one being used for leaving a half of the region and another being used for leaving all the regions, or a method using a gray tone mask which can change an amount of exposure to be performed on the insulating film 55 depending on a place on the insulating film by placing a pattern in a finer manner that exceeds a limit of resolution ability of exposure so that a semi-transmission state is produced, can be employed.

Next, as shown in FIG. 3 (though roughly), the orientating film 34 is formed on the TFT substrate 10 having a thickness of 40 nm to 80 nm by a printing method and the formed orientating film 34 is burned at a temperature of about 200° C. to 230° C. to perform orientation. on the other hand, the color filter 21 is formed on the transparent insulating substrate 20a corresponding to a display region on which the facing electrode 33 made up of a transparent conductive film such as ITO or a like is formed. Similarly, on the facing substrate 20 with the black matrix 22 being formed in its surrounding portion is formed an orientating film 34 having a thickness of 40 nm to 80 nm by the printing method and the formed orientating film 34 is burned at a temperature of about 200° C. to 230° C. to perform orientation. The facing substrate 20 is overlaid on the TFT substrate 10 with the sealing material 23 made up of an epoxy resin adhesive, plastic grains or a like and the in-plane spacer 35 being interposed between the facing substrate 20 and the TFT substrate 10 with a specified gap between them in such a manner that surfaces of the orientating films 34 are disposed to be opposite to each other. Then, the liquid crystal 36 is injected between the TFT substrate 10 and the facing substrate 20 and a space in which the liquid crystal 36 has been injected, that is, an injecting port of the sealing material 23 is sealed hermetically with the hole-sealing material 24 made of a UV (Ultraviolet) curing-type acrylate resin. Finally, on a side being opposite to a surface of a film of the facing substrate 20 are pasted a ¼ wavelength plate 37 and a polarizer 38 to finish the reflective-type LCD.

Then, though not shown in the drawing, an IC chip operating as an driving circuit at portions of the scanning line terminal 15, the signal line terminal 16, and the common line terminal 18 is packaged with COG technology to finish the reflective-type LCD. At this point, it is preferable that a connecting portion between the terminal portion connecting electrode 63 and the chip packaged with COG technology is coated with a resin such as a silicon resin being moisture-resistant (described above).

Second Embodiment

A conceptual diagram of configurations of a TFT substrate 10, a plan view of a panel, a cross-sectional view of the panel in the second embodiment are the same as those in the first embodiment (FIG. 1 to FIG. 3). However, since a configuration of a TFT of the second embodiment is different from that of the first embodiment, a black matrix 22 is placed in a portion corresponding to the TFT 14 on the facing substrate 20.

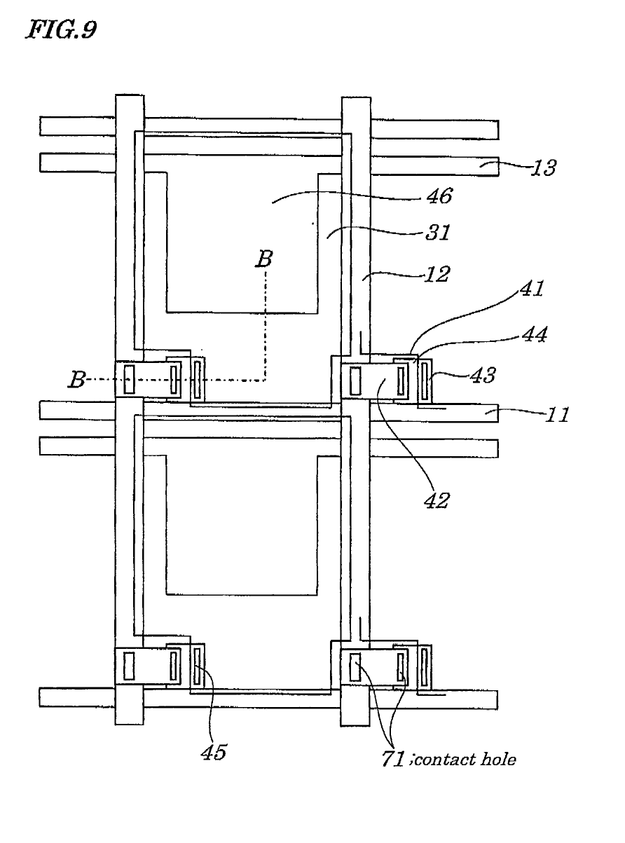

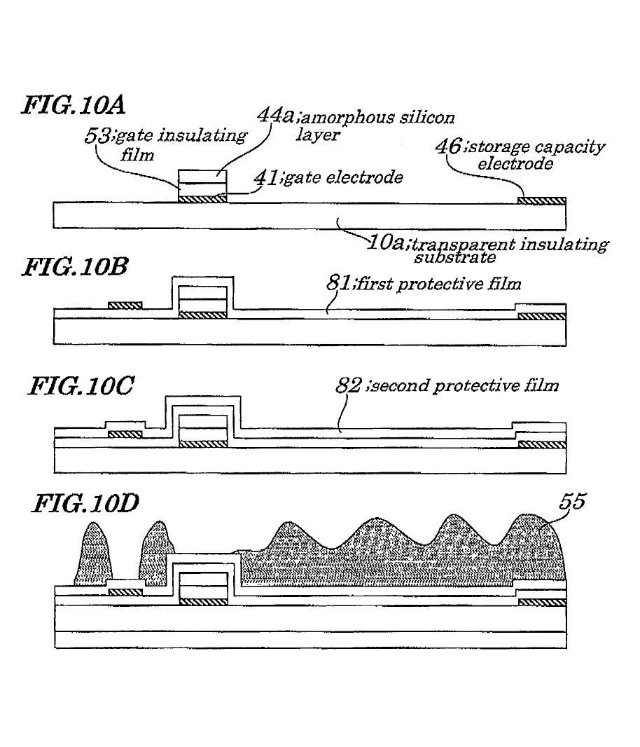

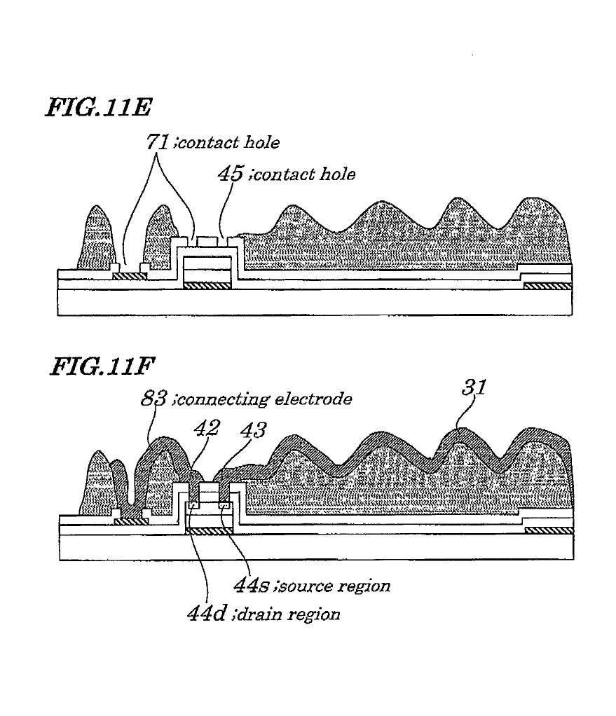

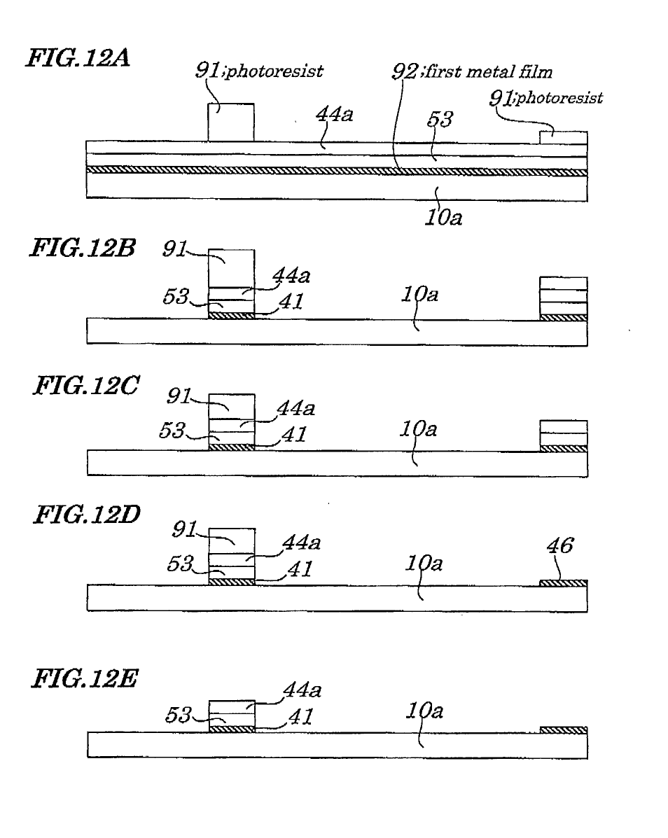

Next, configurations and methods for manufacturing the TFT substrate 10 of the reflective-type LCD of the second embodiment will be described in detail by referring to FIG. 9 to FIG. 12. FIG. 9 is a plan view illustrating a configuration of one pixel portion on the TFT substrate 10 of the reflective-type LCD of the second embodiment. FIGS. 10A, 10B, 10C, and 10D are cross-sectional views of processes employed in the method of manufacturing the TFT substrate 10 of the reflective-type LCD, taken along a line B-B of FIG. 9. FIGS. 11E and 11F are also cross-sectional views of processes employed in the method of manufacturing the TFT substrate 10 of the reflective-type LCD, taken along the line B-B of FIG. 9. FIGS. 12A, 12B, 12C, 12D, and 12E are cross-sectional views illustrating processes employed in the method for the TFT substrate 10 of the reflective-type LCD of the second embodiment. In the second embodiment, an example is shown in which an inverted staggered channel protective—type TFT in which a photo-process is reduced is used as a switching element which corresponds to a pixel portion existing on a most outside surrounding portion on a leftmost side in FIG. 1. Configurations shown in FIGS. 7A to 7E and 8A to 8E can be used also in the second embodiment.

In the embodiment, as shown in FIG. 11F, unlike in the case of the first embodiment, a channel protective-type TFT is employed. The method for manufacturing the TFT substrate 10 having the above configuration chiefly includes, as shown in FIG. 10A to FIG. 11F, and FIGS. 7A to 7E and FIGS. 8A to 8E, (1) a process of forming a metal film for a gate electrode 41, a gate insulating film 53 and a-Si layer 44a, and of performing patterning on them, (2) a process of forming a first protective film 81 and a metal film for a signal line 12, and of performing patterning on them, (3) a process of forming a second protective film 82 and an insulating film 55, and of performing patterning on them and of changing a shape of a surface of an insulating film 55, (4) a process of performing patterning on the first protective film 81 and the second protective film 82, (5) a process of doping with an element exhibiting a valence of V, of forming a- metal film for a drain electrode 42, source electrode 43, and reflective electrode 31, and of performing patterning on them.

As shown in FIG. 10A, FIG. 7A, and FIG. 8A, first, a metal film made of a metal such as Cr or a like having a thickness of 100 nm to 300 nm is formed, by sputtering, on a transparent insulating substrate 10a made of a non-alkaline glass having a thickness of 0.5 mm and then a gate insulating film 53 made of silicon nitride having a thickness of 300 nm to 500 nm and a non-doped a-Si film is formed by plasma CVD and patterning is performed on these films using photolithography to form a gate electrode 41, an gate insulating film 53 and an a-Si layer 44a so that each of a gate electrode 41, a gate insulating film 53, and an a-Si layer 44a has a same shape as the gate electrode 41 and so that the three layers are of a three-stacked structure and, at the same time, a scanning line (not shown), a common line (not shown), a storage capacity electrode 46, a scanning line terminal 15, a signal line terminal 16, a terminal portion lower layer metal film 61 of a common line terminal 18, and a signal line drawing wiring 64 are formed.

This process will be explained in detail by referring to FIG. 12. First, a coat of the photoresist 91 is put on a first metal film 92 stacked on the transparent insulating substrate 10a, the gate insulating film 53 and the a-Si layer 44a. Then, in the same way as is used in the first embodiment, by performing exposure by using a half tone mask or a gray tone mask and by performing development using a developing agent, a photoresist 91 having a large film thickness is formed at a place on which the gate electrode 41 is formed, a photoresist 91 having a small thickness is formed at a place on which a scanning line 11 (not shown), a common line 13 (not shown), a stored capacity electrode 46, a scanning line terminal 15, a signal line terminal 16, a terminal portion lower layer metal film 61 of a common line terminal 18 (not shown), and a signal line drawing wiring 64 (not shown) are formed. The photoresists each having a different film thickness may be formed by changing an amount of exposure using different two masks, one being used for leaving a half of the region and another being used for leaving all the regions (FIG. 12A).

Next, dry etching is performed on the a-Si layer 44a, the gate insulating film 53, and the first metal film 92 using the photoresist 91 as a mask. In the above dry etching, it is preferable that a reactive ion etching (RIE) is used in which an etching gas is changed depending on a kind of a film in order to prevent side etching of the gate insulating film 53 or the first metal film 92 (FIG. 12B).

Next, by performing the etching on the photoresist 91 using an oxygen (O₂) ashing method, a photoresist having the small film thickness is removed (FIG. 12C). Then, dry etching is performed on the a-Si film and silicon nitride film by using a photoresist 91 having the large film thickness that has remained left as a mask (FIG. 12D).

Finally, by peeling off and removing the photoresist 91, a three-layer component including the gate electrode 41, gate insulating film 53 and a-Si layer 44a, scanning line 11 (not shown), common line 13 (not shown), stored capacity electrode 46, scanning line terminal 15, signal line terminal 16, terminal portion lower layer metal film 61 of a common line terminal 18 (not shown), signal line drawing wiring 64 (not shown) are formed (FIG. 12E).

Again, by referring to FIG. 10, the first protective film 81 made of silicon nitride having a film thickness of 100 nm to 300 mm is formed by plasma CVD. Next, a second metal film made of metal such as Cr having a film thickness of 100 nm to 300 nm is formed by sputtering and, then, patterning is performed using photolithography to form a signal line 12 (FIG. 10B, FIG. 7B, and FIG. 8C).

Next, a second protective film 82 made of silicon nitride having a film thickness of 100 nm to 200 nm is formed by plasma CVD (FIG. 10C, FIG. 7C, and FIG. 8D) Then, in the same manner as in the first embodiment, an insulating film 55 is formed and processing of changing a surface shape is performed (FIG. 10D, FIG. 7C, and FIG. 8D).

Then, by performing patterning on the a-Si layer 44a, the signal line 12 in the vicinity of the a-Si 44a, the protective film 82 on a terminal of the signal line 12 formed on the first protective film 81, the scanning line terminal 15, the signal line terminal 16, the terminal portion lower layer metal film of the common line terminal 18, and the second protective film 82 and the protective film 81 on the signal line drawing wiring 64, each of contact holes 45, 71, 62, and 65 is formed in an opened state (FIG. 1E, FIG. 7D, and FIG. 8E). The first protective film 81 and second protective film 82 are used to prevent impurities of ion or a like from being diffused to the a-Si layer 44 and an operational failure from occurring in the TFT14.

Next, for example, plasma processing is performed using phosphine (PH₃) and the a-Si layer 44a is dopped with an element exhibiting a valence of V such as phosphorus (P), through the contact holes 45 and 71, and the drain region 44d and source region 44s being made of the n⁺-type a-Si are formed.

Then, a metal film having a high melting point such as Cr or Mo and having a thickness of 50 nm and Al—Nd alloy film are sequentially formed by sputtering and patterning is performed using photolithography on the films to form the drain electrode 42, source electrode 43, reflective electrode 31, connecting electrodes 66 and 83, and terminal portion connecting electrode 63 and to complete the manufacturing of the TFT substrate 10 (FIG. 11 (F), FIG. 7E, and FIG. 8F) .

In the embodiment, in the configuration of the film of the reflective electrode 31 and of the film of each of connecting electrodes 66, if an Al alloy film is used in a form of a single film, the Al alloy is diffused in the n⁺-type a-Si layer of the drain region 44d and the source region 44c, which causes an ohmic contact to be unstable and, therefore, the film having a high melting point is stacked below the Al alloy film as a diffusing preventive layer.

In the embodiment, an example is shown in which the second protective film 82 is formed, however, since the insulating film 55 can provide same functions as those of the second protective film 82, the second protective film 82 is not required. In this case, since a number of times of formation of films can be reduced by one time and a process of forming contact holes each having a different depth is not needed, the reflective-type LCD of the present invention can provide an advantage that the etching process is made easy.

Thereafter, by the same method as in the first embodiment, the LCD panel is manufactured and the reflective-type LCD of the present invention is finished.

Third Embodiment

A conceptual diagram of configurations of a TFT substrate, a plan view of a panel, a cross-sectional view of the panel in the third embodiment are the same as those in the first embodiment (FIG. 1 to FIG. 3) and their descriptions are omitted accordingly.

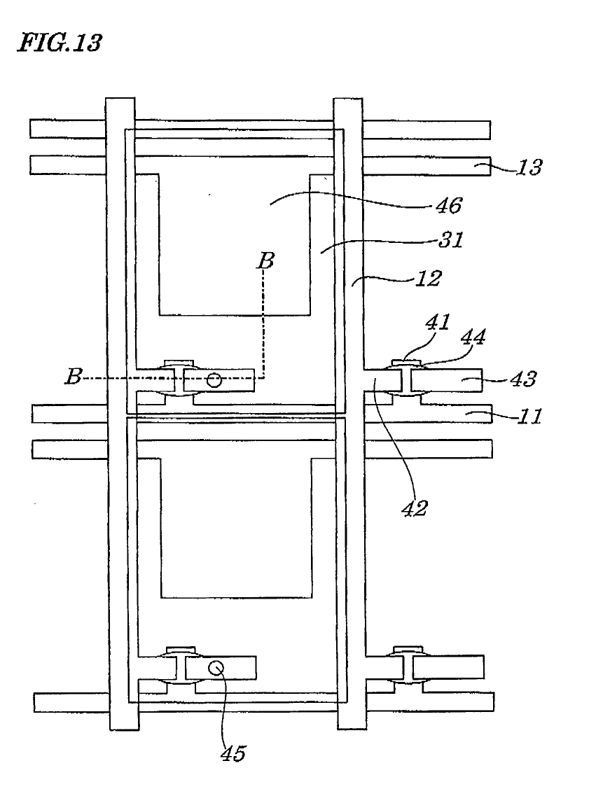

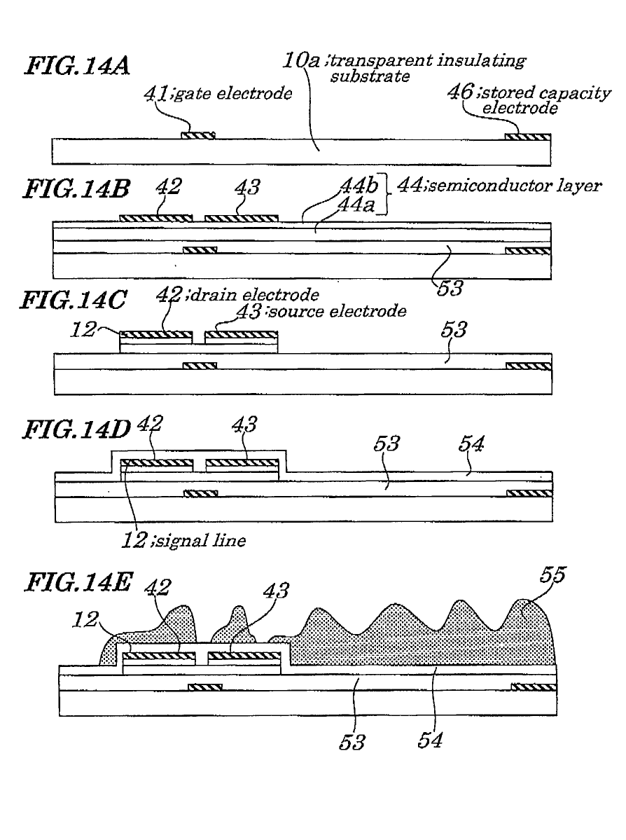

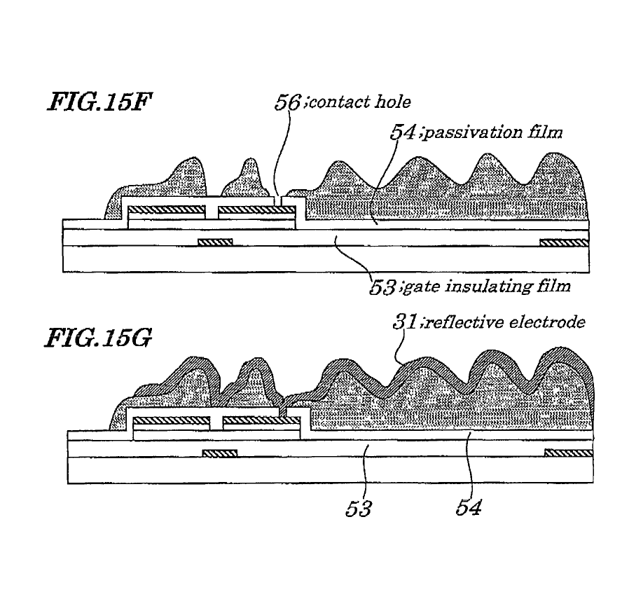

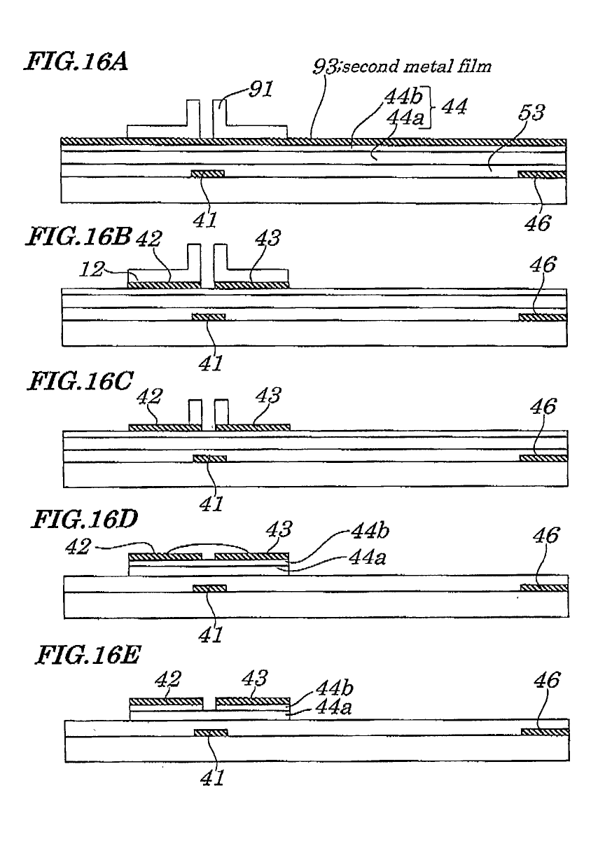

Next, configurations of the TFT substrate 10 of the reflective-type LCD and its manufacturing method of the third embodiment will be described by referring to FIG. 13 to FIG. 16. FIG. 13 is a plan view of configurations of one pixel portion on the TFT substrate 10 of a reflective-type LCD according to the third embodiment of the present invention. FIGS. 14A to 14E are cross-sectional views of processes employed in a method of manufacturing the TFT substrate 10 of the reflective-type LCD, taken along a line B-B of FIG. 13. FIGS. 15F and 15G are cross-sectional views of processes employed in the method of manufacturing the TFT substrate 10 in the reflective-type LCD, taken along the line B-B of FIG. 13. FIGS. 16A to 16E are cross-sectional views explaining processes employed in FIGS. 14B and 14C.

In the third embodiment, an example is shown in which an inverted staggered channel etching-type TFT in which a number of photo-processes is reduced is used as a switching element which corresponds to a pixel portion existing on a most outside surrounding portion on a leftmost side in FIG. 1. Configurations shown in FIGS. 7A to 7E and FIGS. 8A to 8F can be used also in the third embodiment.

In the third embodiment, as shown in FIG. 15G, the channel etching-type TFT is used and a shape of each of the source electrode, drain electrode, semiconductor layer is different from that employed in the first embodiment.

The method for manufacturing the TFT substrate having above configurations is made up of five processes including, as shown in FIG. 14A to FIG. 15G, (1) a process of forming a metal film for the gate electrode 41 and of performing patterning on the metal film of the gate electrode 41, (2) a process of forming the gate insulating film 53, a-Si layer 44a, and n⁺-type a-Si layer 44b, a metal film for the drain electrode 42 and source electrode 43, of performing patterning on them and of performing patterning on the n⁺-type a-Si layer 44b and a-Si layer 44a, (3) a process of forming a passivation film 54 and insulating film 55, of performing patterning on them, and of changing a shape of a surface of the insulating film 55, (4) a process of performing patterning on the passivation film 54, and (5) a process of forming a metal film for the reflective electrode 31 and of performing patterning on the metal film of the reflective electrode 31.

First, as shown in FIG. 14A and FIG. 7A, a first metal film 92 made of non-alkaline glass having a thickness of 0.5 mm is formed by sputtering on a transparent insulating substrate 10a and patterning is performed using photolithography on the first metal film 92 to form a gate electrode 41, scanning line 11 (not shown), common line 13 (not shown), stored capacity electrode 46, scanning terminal 15, signal line terminal 16, terminal portion lower metal film 61 of a common line terminal 18, and signal line drawing wiring 64 (not shown).

Next, as shown in FIGS. 14B and 14C, and FIG. 7B, a gate insulating film 53 made of silicon nitride having a thickness of 300 nm to 500 nm, a-Si layer made of non-dopped a-Si, and n⁺-type a-Si layer made of doped n⁺-type a-Si are sequentially formed by plasma CVD and then a second metal film 82 made of Cr having a thickness of 100 nm to 300 nm is formed by sputtering and then, by photolithography, the drain electrode 42, source electrode 43 and signal line 12 are formed, and further a semiconductor layer 44 made up of the a-Si layer 44a and n⁺-type a-Si layer are formed.

These processes are described by referring to FIG. 16. A coat of a photoresist is put on the a-Si layer 44a, n⁺-type a-Si layer 44b, and the second metal layer 93 all being stacked on the gate insulating film 53 and, in the same way employed in the forming process of the insulating film 55 in the first embodiment and by performing exposure using a half tone mask or gray tone mask and development using a developing agent, the photoresist 91 having a large film thickness is formed in a region in the vicinity of a channel portion in which the drain electrode 42 and source electrode 43 are to be formed and the photoresist 91 having a small film thickness is integrally formed in a region in which other portion of the drain electrode 42 and source electrode 43 and the signal line 12 are to be formed. In this case, the photoresist 91 can be formed by changing an amount of exposure using different two masks, one being used for leaving a half of the region and another being used for leaving all the regions.

Next, etching is performed on the second metal film 93 by the photoresist 91 as a mask (FIG. 16).

Next, by performing the etching on the photoresist 91 using an oxygen (O₂) ashing method, a photoresist having the small film thickness is removed (FIG. 16C). Then, for example, reflow processing is performed on a thicker portion of the photoresist 91 that has been left by using a vapor of an organic solvent such as N-methyl-2-pyrrolidone (NMP). Then, dry etching is performed on the n⁺-type a-Si layer 44b and a-Si layer 44a, using the photoresist 91 having undergone the reflow process, drain electrode 42, source electrode 43 as a mask. It is preferable that an RIE is used in order to prevent side etching of the n⁺-type a-Si layer 44b and a-Si layer 44a (see FIG. 16D).

Finally, after the removal of the photoresist 91, dry etching is performed using the drain electrode 42 and the source electrode 43 as masks to remove the n⁺-type a-Si layer 44b and a-Si layer 44a existing between the drain electrode 42 and the source electrode 43 (see FIG. 16E). Moreover, this process may be performed at the same time when the drain electrode 42 and source electrode 43 are formed (in the process shown in FIG. 16B).

Next, as shown in FIG. 14, the film made of silicon nitride having a film thickness of 100 nm to 300 nm is formed by plasma CVD to form the passivation film 54 (FIG. 14D and FIG. 7C).

Next, in the same way as in the first embodiment, the insulating film 55 is formed and a process of changing a shape of a surface of the insulating film 55 is performed (FIG. 14E and FIG. 7C).

Then, patterning is performed, using photolithography, on the source electrode 43, passivation film 54 on an end portion of the signal line 12 formed on the gate insulating film 53, scanning line terminal 15, signal line terminal 16, terminal portion lower layer metal film 61 of the common line terminal 18, passivation film 54 and the gate insulating film 53 on the signal line drawing wiring 64 (not shown) to form each of contact holes 56, 62, and 65 (see FIG. 15F, FIG. 7D).

Next, an Al—Nd alloy film having a thickness of 100 nm to 300 nm is formed by sputtering and then patterning is performed using photolithography to form a reflective electrode 31, terminal portion connecting electrode 66 (not shown) to finish the TFT substrate (FIG. 15G and 7E). Configurations of the reflective electrode 31 and each of the connecting electrodes 66 and a material for the Al alloy are the same as shown in the first embodiment.

Cross-sectional views of the signal line 12 and the signal line drawing wiring 64 in the third embodiment are the same as those shown in FIGS. 8A to 8F except that the n⁺-type a-Si layer 44b and a-Si layer 44a are stacked below the signal line 12 in a manner so as to have the same configuration as the signal 12.

Thereafter, by the same method as in the first embodiment, the LCD panel is manufactured and the reflective-type LCD of the present invention is finished.

Fourth Embodiment

A conceptual diagram of configurations of a TFT substrate, a plan view of a panel, a cross-sectional view of the panel in the fourth embodiment are the same as those in the first embodiment (FIG. 1 to FIG. 3) and their descriptions are omitted accordingly.

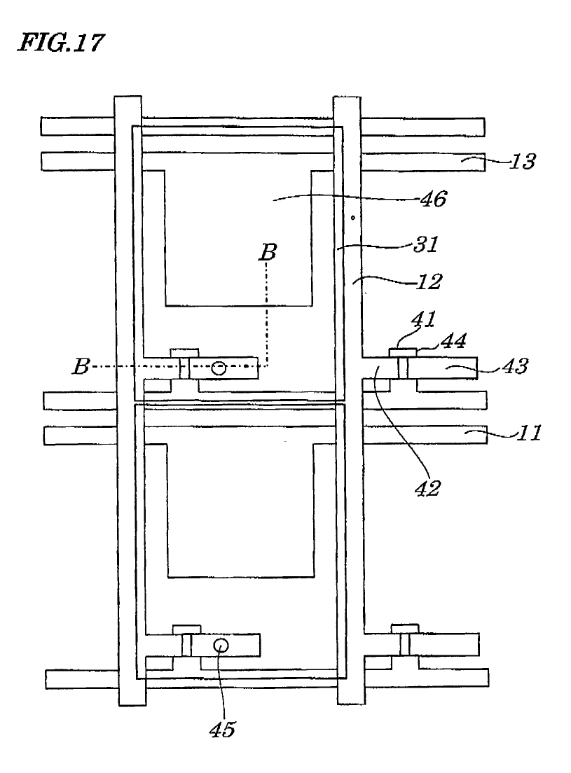

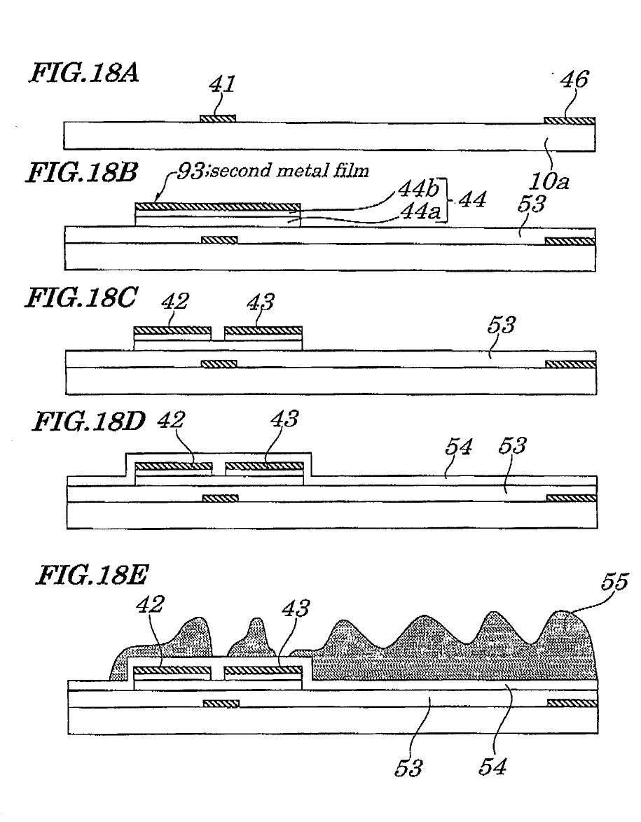

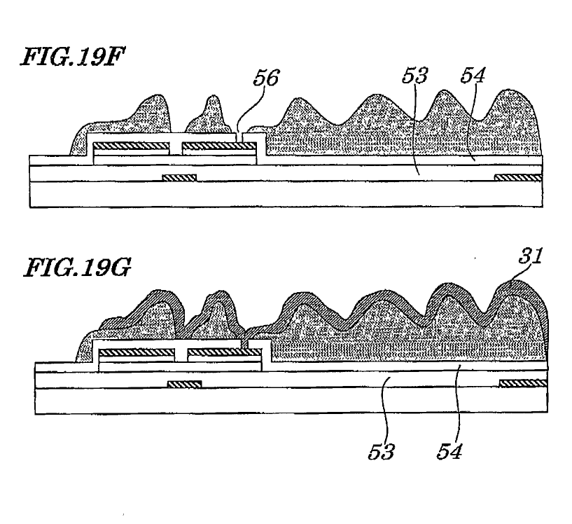

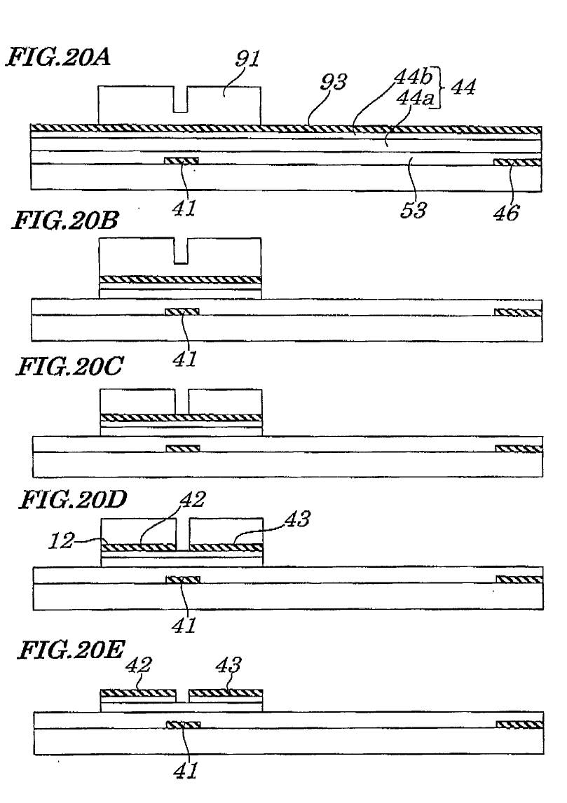

Next, configurations of the TFT substrate of the reflective-type LCD and its manufacturing method of the third embodiment will be described by referring to FIG. 17 to FIG. 20. FIG. 17 is a plan view of a configuration of one pixel portion on the TFT substrate 10 of a reflective-type LCD of a fourth embodiment of the present invention. FIGS. 18A to 18E are cross-sectional views of processes employed in a method of manufacturing the TFT substrate 10 of the reflective-type LCD, taken along a line B-B of FIG. 17. FIGS. 19F and 19G are cross-sectional views of processes employed in a method of manufacturing the TFT substrate 10 of the reflective-type LCD, taken along the line B-B of FIG. 17. FIGS. 20A to 20E are cross-sectional views explaining processes employed in FIGS. 18B and 18C.

In the fourth embodiment, an example is shown in which an inverted staggered channel etching-type TFT in which a number of photo-processes is shortened is used as a switching element which corresponds to a pixel portion existing on a most outside surrounding portion on a leftmost side in FIG. 1. Configurations shown in FIGS. 7A to 7E and FIGS. 8A to 8F can be used also in the fourth embodiment.

In the fourth embodiment, as shown in FIG. 19G, a channel etching-type TFT is used and configurations of the fourth embodiment are similar to those in the third embodiment, however, its manufacturing method is somewhat different from that in the third embodiment. The method for manufacturing the TFT substrate having above configurations is made up of five processes including, as shown in FIG. 18A to FIG. 19G, (1) a process of forming a metal film for the gate electrode 41 and of performing patterning on the metal film of the gate electrode 41, (2) a process of forming the gate insulating film 53, a-Si layer 44a, n⁺-type a-Si layer 44b, a metal film for the drain electrode 42 and source electrode 43, and of performing patterning on the n⁺-type a-Si layer 44b and a-Si layer 44a, and performing on the drain electrode 42 and source electrode 43 (channel formation) , (3) a process of forming a passivation film 54 and an insulating film 55, of performing patterning on them, and of changing a shape of a surface of the insulating film 55, (4) a process of performing patterning on the passivation film 54, and (5) a process of forming a metal film for the reflective electrode 31 and of performing patterning on the metal film of the reflective electrode 31.

First, as shown in FIG. 18A and FIG. 7B, a first metal film 92 made of non-alkaline glass having a thickness of 0.5 mm is formed by sputtering on a transparent insulating substrate 10a and patterning is performed using photolithography on the first metal film 92 to form a gate electrode 41, scanning line 11 (not shown), common line 13 (not shown), stored capacity electrode 46, scanning terminal 15, signal line terminal 16, terminal portion lower metal film 61 of a common line terminal 18, and signal line drawing wiring 64 (not shown).

Next, as shown in FIGS. 18B, 18C, and FIG. 7B, a gate insulating film 53 made of silicon nitride having a thickness of 300 nm to 500 nm, a-Si layer made of non-dopped a-Si having a thickness of 150 nm to 300 nm, and n⁺-type a-Si layer made of doped n⁺-type a-Si having a thickness of 30 to 50 nm are sequentially formed by plasma CVD and then a second metal film 82 made of Cr having a thickness of 100 nm to 300 nm is formed by sputtering and then, by using photolithography, after a portion of a second metal film 93 in which the signal line 12, source electrode 43 and drain electrode 42 are to be formed and a portion in which a channel is to be formed and a semiconductor layer 44 made up of the a-Si layer 44a and n⁺-type a-Si layer 44b have been formed in such a manner that each of the corresponding second metal film 93 and the semiconductor layer 44 has a same configuration, etching is performed on the second metal film 93 in which the channel portion is to be formed and on the n⁺-type a-Si layer 44b to form the drain electrode 42 and the source electrode 43.

These processes are described by referring to FIG. 20. A coat of a photoresist is put on the a-Si layer 44a, n⁺-type a-Si layer 44b, and the second metal layer 93 all being stacked on the gate insulating film 53 and, in the same way employed in the forming process of the insulating film 55 in the first embodiment and by performing exposure using a half tone mask or gray tone mask and development using a developing agent, the photoresist 91 having a large film thickness is formed in a region in which the drain electrode 42, source electrode 43, and signal line are to be formed and the photoresist 91 having a small film thickness is integrally formed in a region in which the channel is formed. In this case, the photoresist 91 can be formed by changing an amount of exposure using different two masks, one being used for leaving a half of the region and another being used for leaving all the regions (see FIG. 20A).

Next, etching is performed sequentially on the second metal film 93, n⁺-type a-Si layer 44b and a-Si layer 44a by the photoresist 91 as a mask (FIG. 20B). It is preferable that, when the etching is performed on semiconductor layer 44, a RIE is used in order to prevent side etching of the n⁺-type a-Si layer 44b and a-Si layer 44a. Next, by performing the etching on the photoresist 91 using an oxygen (O₂) ashing method, a photoresist having the small film thickness is removed (FIG. 20C).

By using the photoresist 91 that has been left and has a larger thickness as a mask, etching is performed in a portion of the second metal film 93 that serves as the channel to form the drain electrode 42 and source electrode 43 (FIG. 20D).

Finally, after the removal of the photoresist 91, dry etching is performed using the drain electrode 42 and the source electrode 43 as a mask to remove the n⁺-type a-Si layer 44b and a-Si layer 44a existing between the drain electrode 42 and the source electrode 43 (see FIG. 16E) . Moreover, this process may be performed at the same time when the drain electrode 42 and source electrode 43 are formed (in the process shown in FIG. 20D).

Next, as shown in FIG. 18, the film made of silicon nitride having a film thickness of 100 nm to 300 nm is formed by plasma CVD to form the passivation film 54 (FIG. 18D and FIG. 7C).

Then, in the same way as in the first embodiment, the insulating film 55 is formed and a process of changing a shape of a surface of the, insulating film 55 is performed (FIG. 18E and FIG. 7C).

Then, patterning is performed, using photolithography, on the source electrode 43, passivation film 54 on an end portion of the signal line 12 formed on the gate insulating film 53, scanning line terminal 15, signal line terminal 16, terminal portion lower layer metal film 61 of the common line terminal 18, passivation film 54 and the gate insulating film 53 on the signal line drawing wiring (not shown) to form each of contact holes 56, 62, and 65 (see FIG. 19F, and FIG. 7D).

Next, an Al—Nd alloy film having a thickness of 100 nm to 300 nm is formed by sputtering and then patterning is performed using photolithography to form the reflective electrode 31, terminal portion connecting electrode 63, and connecting electrode (not shown) to finish the TFT substrate (FIG. 19G and 7E). Configurations of the reflective electrode 31 and each of the connecting electrodes 66 and a material for the Al alloy are the same as shown in the first embodiment.

Cross-sectional views of the signal line 12 and the signal line drawing wiring 64 in the fourth embodiment are the same as those shown in FIGS. 8A to 8F except that the n⁺-type a-Si layer 44b and a-Si layer 44a are stacked below the signal line 12 in a manner so as to have the same configuration as the signal 12.

Thereafter, by the same method as in the first embodiment, the LCD panel is manufactured and the reflective-type LCD of the present invention is finished.

Thus, in the reflective-type LCD of the present invention, since the mounting of the transparent pixel electrode is not required, the number of photo-processes can be reduced by one process by forming the reflective electrode and terminal portion connecting electrode using an Al alloy being excellent in resistance to pitting corrosion.

Fifth Embodiment

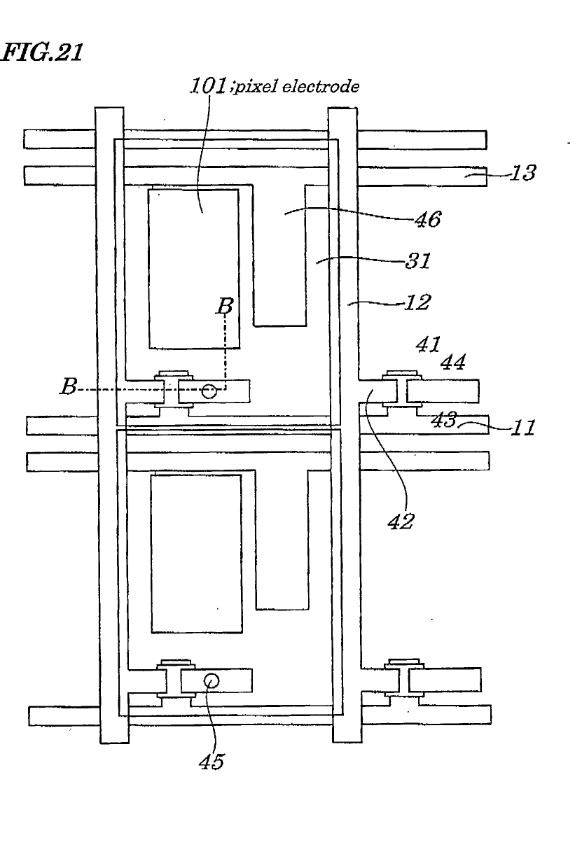

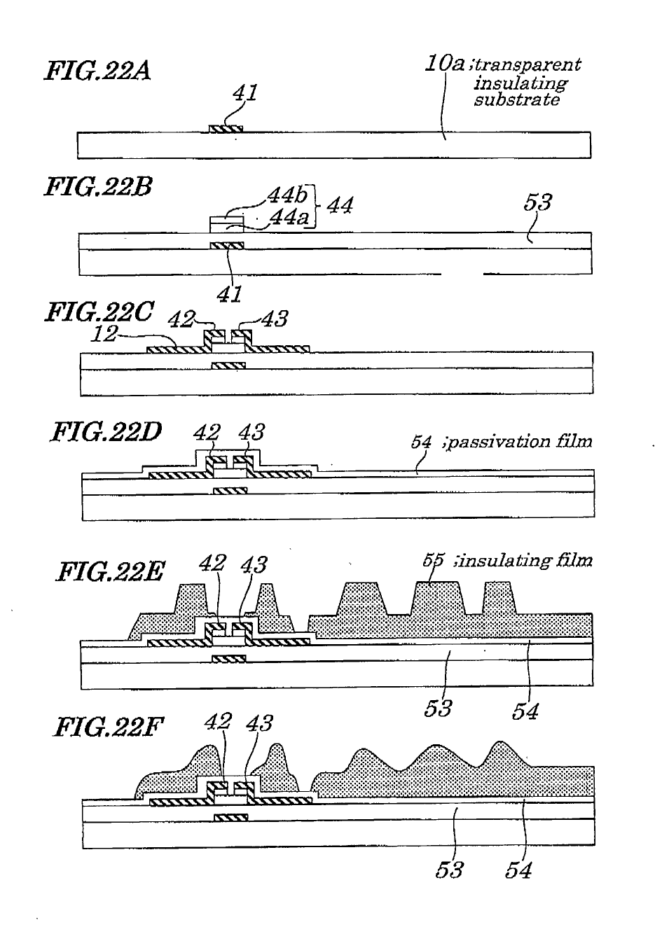

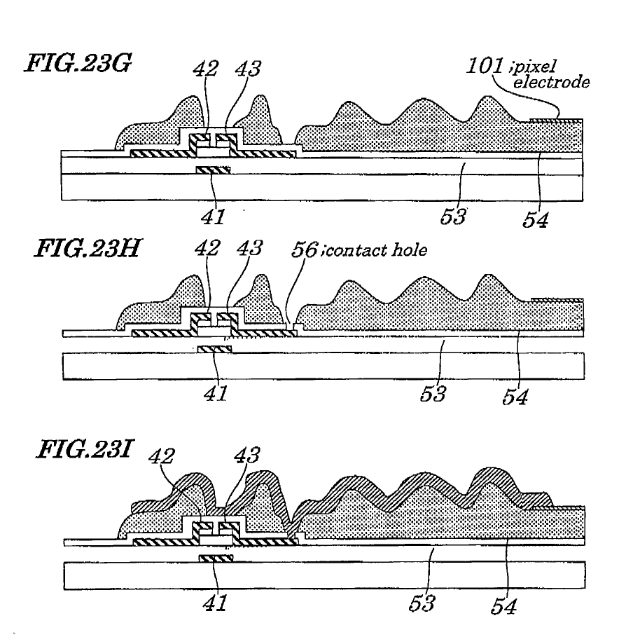

A semi-transparent reflective-type LCD of a fifth embodiment will be described by referring to FIG. 21 to FIG. 23I, FIG. 21 is a plan view of a configuration of one pixel portion on a TFT substrate 10 of the semi-transparent reflective-type LCD of the fifth embodiment. FIGS. 22A to 22F are cross-sectional views of processes employed in a method of manufacturing the TFT substrate 10 of the semi-transparent reflective-type LCD, taken along a line B-B of FIG. 21. FIGS. 23G to 23I are cross-sectional views of processes employed in the method of manufacturing the TFT substrate 10 of the semi-transparent reflective-type LCD, taken along the line B-B of FIG. 21. A conceptual diagram of configurations of the TFT substrate 10, a plan view of its panel, a cross-sectional view of the panel in the fifth embodiment are the same as those in the first embodiment (FIG. 1 to FIG. 3), however, the semi-transparent reflective-type LCD of the fifth embodiment differs from those in the first embodiment in that a pixel electrode 101 made up of a transparent conductive film, together with a reflective electrode 31, on the TFT substrate 10 is placed and in that a polarizer (not shown) is placed on a surface on a side being opposite to a surface being opposite to a facing substrate (not shown) of the TFT substrate 10. A display is achieved by using two types of light, one being reflective light which enters from a rear side of the facing substrate and is reflected off the reflective electrode 31 and is then emitted to an outside and another being transmissive light which enters from a rear side of the TFT substrate 10 and transmits through the transparent pixel electrode 101, liquid crystal layer 36 (not shown), and the facing substrate and then is emitted to an outside.

In the fifth embodiment, an example is shown in which the TFT substrate 10 of the first embodiment is employed as the TFT substrate in the semi-transparent reflective-type LCD of the fifth embodiment which corresponds to a pixel portion existing on a most outside surrounding portion on a leftmost side in FIG. 1. Configurations shown in FIGS. 7A to 7E and FIGS. 8A to 8F can be used also in the fifth embodiment.

The method for manufacturing the TFT substrate having above configurations is made up of seven processes including, as shown in FIG. 22A to FIG. 23I, (1) a process of forming a metal film for the gate electrode 41 and of performing patterning on it, (2) a process of forming the gate insulating film 53, a-Si layer 44a, n⁺-type a-Si layer 44b and a metal film for the drain electrode 42 and source electrode 43, and of performing patterning on the metal film of the drain electrode 42 and source electrode 43, (3) a process of forming a metal film for the drain electrode 42 and source electrode 43 and of performing patterning on the metal film of the drain electrode 42 and source electrode 43, (4) a process of forming the passivation film 54 and insulating film 55 and of performing patterning on them and of changing a shape of a surface of the insulating film 55, (5) a process of forming a transparent conductive film for the pixel electrode 101 and of performing patterning on the transparent conductive film of the pixel electrode 101, (6) a process of performing patterning on the passivation film 54, and (7) a process of forming a metal film for the reflective electrode 31 and of performing patterning on the metal film of the reflective electrode 31.

First, by totally the same method as used in the first embodiment, the TFT is formed and the passivation film 54 and the insulating film 55 are formed on the TFT (see FIGS. 22A to 22F, FIGS. 7A to 7C, and FIGS. 8A to 8D).

Next, a transparent conductive film made of ITO having a thickness of 40 nm to 100 nm is formed by sputtering and then patterning is performed using photolithography to form a pixel electrode 101 (see FIG. 23G, FIG. 7C, and FIG. 8D).

Next, by totally the same method as used in the first embodiment, contact holes 56, 62, and 65 are formed in the passivation film 54 (see FIG. 23H, FIG. 7D, and FIG. 8E).

Then, a metal film having a high melting point such as Cr or Mo and having a thickness of 50 nm to 200 nm and Al—Nd alloy film having a thickness of 100 nm to 300 nm are sequentially formed by sputtering and patterning is performed using photolithography on the films to form the reflective electrode 31, terminal portion connecting electrodes 63 and connecting electrodes 66 to complete the manufacturing of the TFT substrate 10 (FIG. 23I, FIG. 7E, and FIG. 8F). In the film configuration of the reflective electrode 31 and each of the connecting electrodes 66 of the fifth embodiment, if the Al alloy film is used in a form of a single layer, at a time of development in the photolithography process, a cell reaction occurs between an ITO film of the pixel electrode 101 and the Al alloy film which causes peeling of the Al film, use of a metal film having a high melting point that serves as a reaction preventing layer formed in a layer below the Al alloy film is required. The material for the Al alloy used in the first embodiment is used in the fifth embodiment.

Thereafter, by the same method as in the first embodiment, the LCD panel is manufactured and the reflective-type LCD of the present invention is finished.

Sixth Embodiment

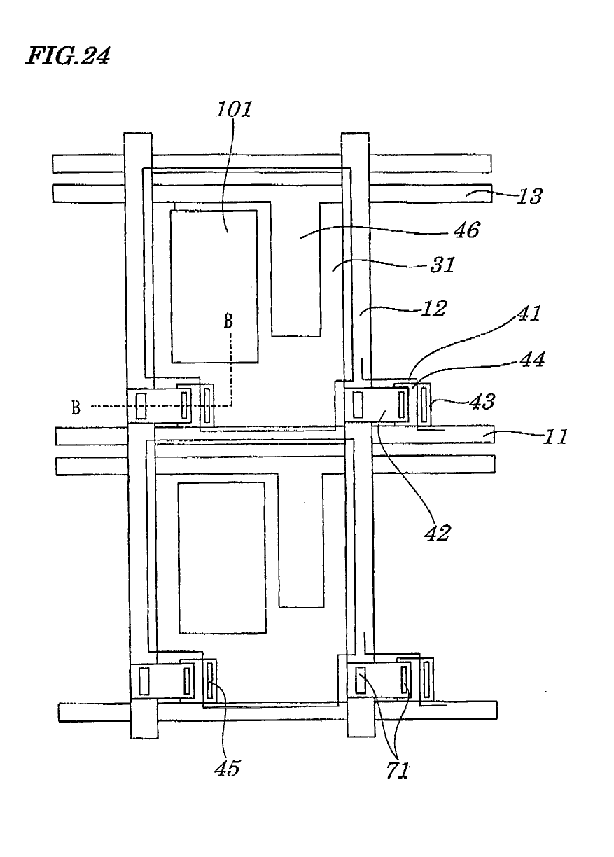

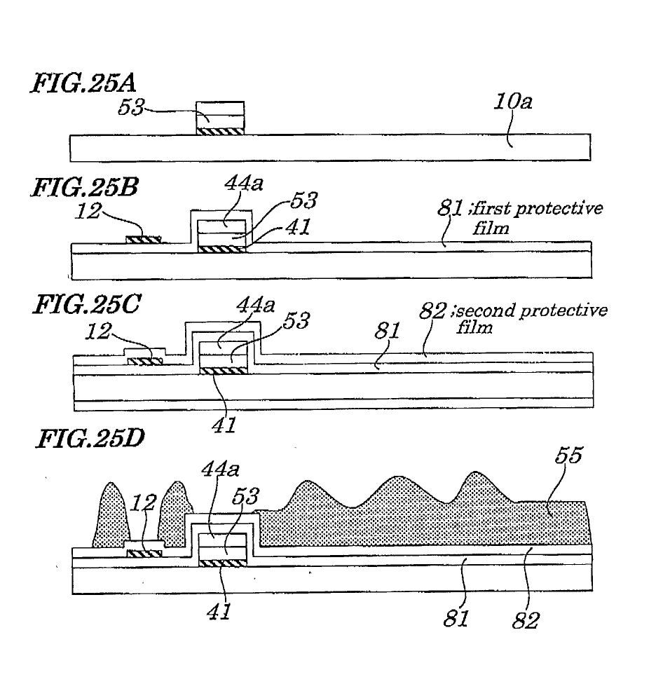

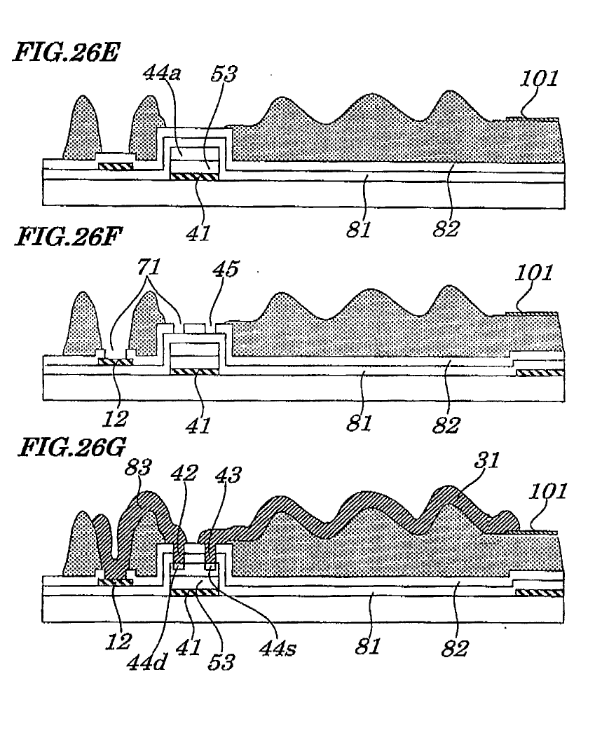

A semi-transparent reflective-type LCD of a sixth embodiment will be described by referring to FIG. 24 to FIGS. 26A to 26G. FIG. 24 is a plan view of configurations of one pixel portion on a TFT substrate 10 of the semi-transparent reflective-type LCD according to the sixth embodiment of the present invention. FIGS. 25A to 25D are cross-sectional views of processes employed in a method of manufacturing the TFT substrate 10 of the semi-transparent reflective-type LCD, taken along a line B-B of FIG. 24. FIGS. 26E, 26F and 26G are cross-sectional views of processes employed in the method of manufacturing the TFT substrate 10 of the semi-transparent reflective-type LCD, taken along the line B-B of FIG. 24. A conceptual diagram of configurations of the TFT substrate 10, a plan view of a panel, a cross-sectional view of the panel in the sixth embodiment are the same as those in the fifth embodiment (FIG. 1 to FIG. 3) and their descriptions are omitted accordingly. In the sixth embodiment, an example is shown in which the TFT substrate 10 of the first embodiment is employed as the TFT substrate 10 in the semi-transparent reflective-type LCD of the fifth embodiment which corresponds to a pixel portion existing on a most outside surrounding portion on a leftmost side in FIG. 1. Configurations shown in FIGS. 7A to 7E and FIGS. 8A to 8F can be used also in the sixth embodiment.

The method for manufacturing the TFT substrate 10 having above configurations is made up of six processes including, as shown in FIG. 25A to FIG. 26G, FIG. 7 and FIG. 8, (1) a process of forming a metal film for the gate electrode 41, a gate insulating film 53 and a-Si layer 44a, and of performing patterning on them, (2) a process of forming a first protective film 81 and a metal film for a signal line 12 and of patterning on them, (3) a process of forming a second protective film 82 and insulating film 55, and of performing patterning on the insulating film 55 and of changing a shape of a surface of the insulating film, (4) a process of forming a transparent conductive film of a pixel electrode 101 and of performing patterning on it, (5) a process of performing patterning on the first protective film 81 and second protective film 82, and (6) a process of doping with an element exhibiting a valence of V and of forming metal films for a drain electrode 42, source electrode 43, and reflective electrode 31 and of performing patterning on them.

First, by totally the same method as in the second embodiment, the TFT is formed and the second protective film 82 and the insulating film 55 are formed on the TFT (see FIGS. 25A to 25D, FIGS. 7A to 7C, and FIGS. 8A to 8D).

Next, a transparent conductive film made of ITO having a thickness of 40 nm to 100 nm is formed by sputtering and then patterning is performed using photolithography to form a pixel electrode 101 (see FIG. 26E, FIG. 7C, and FIG. 8D).

Next, by totally the same method as in the first embodiment, contact holes 56, 62, and 65 are formed in the first protective film 81, second protective film 82 (see FIG. 26F, FIG. 7D, and FIG. 8E).

Then, a metal film having a high melting point such as Cr or Mo and having a thickness of 50 nm to 200 nm and Al—Nd alloy film having a thickness of 100 nm to 300 nm are sequentially formed by sputtering and then patterning is performed using photolithography on the films to form the reflective electrode 31, terminal portion connecting electrodes 63 and connecting electrodes 66 and 83 to finish the manufacturing of the TFT substrate 10 (FIG. 26G, FIG. 7E, and FIG. 8F) . In the embodiment, the film configurations of the reflective electrode 31 and each of the connecting electrodes 66 and 83 described in the fifth embodiment are employed and also the material for the Al alloy used in the first embodiment is used.

Thereafter, by the same method as in the first embodiment, the LCD panel is manufactured and the reflective-type LCD of the present invention is finished

Seventh Embodiment

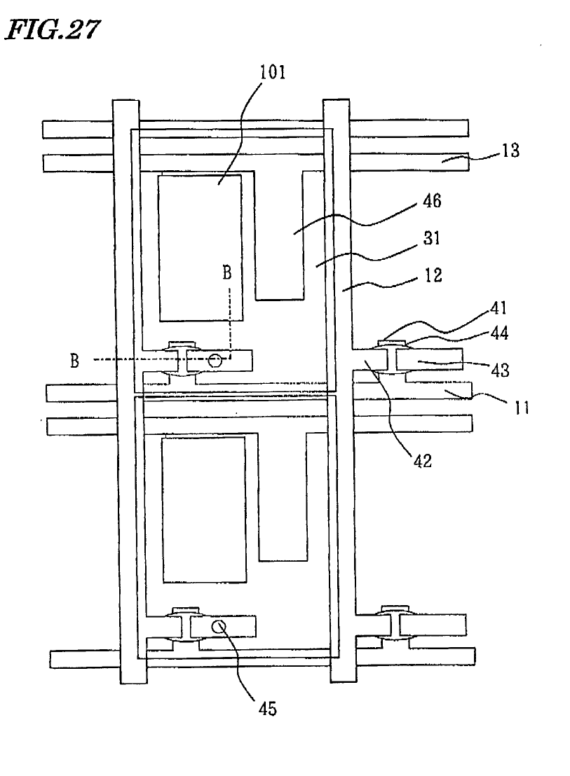

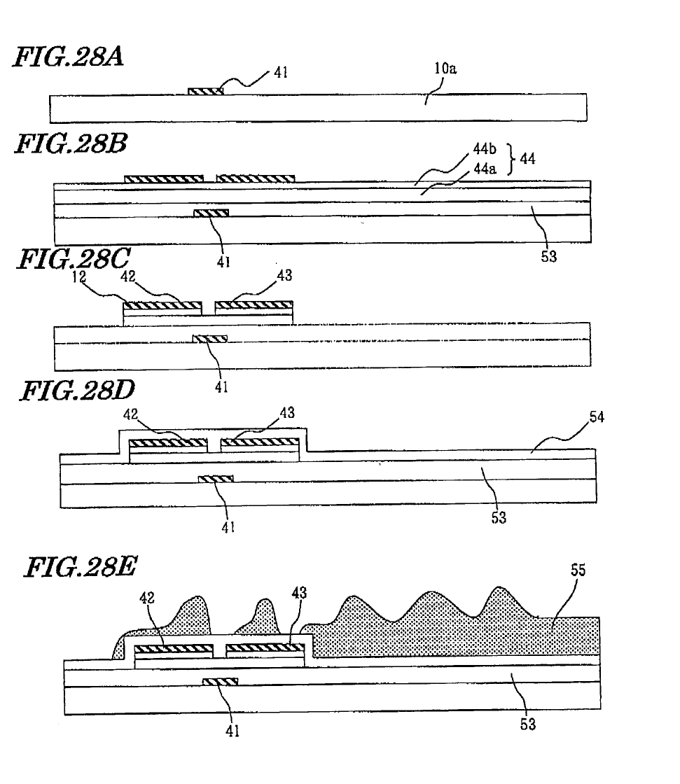

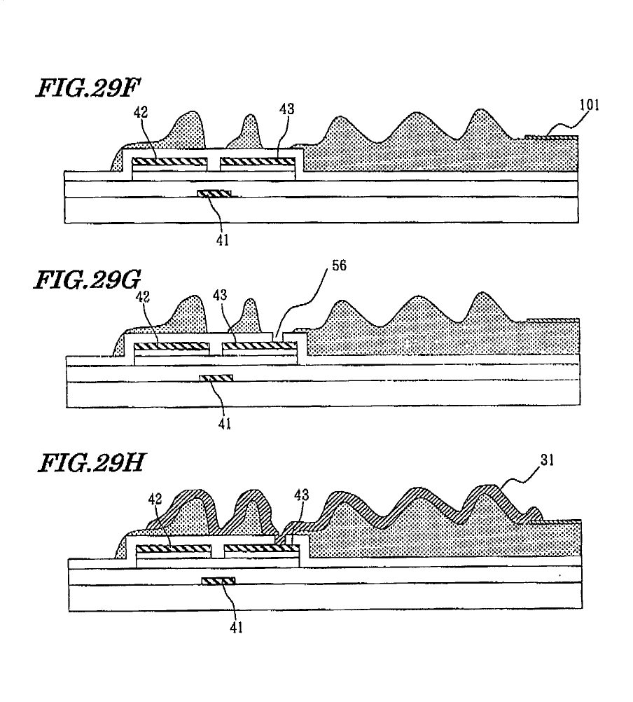

A semi-transparent reflective-type LCD of a seventh embodiment will be described by referring to FIG. 24 to FIGS. 26A to 26G. FIG. 27 is a plan view of configurations of one pixel portion on a TFT substrate 10 of a semi-transparent reflective-type LCD according to the seventh embodiment of the present invention. FIGS. 28A to 28E are cross-sectional views of processes employed in a method of manufacturing the TFT substrate 10 of the semi-transparent reflective-type LCD, taken along a line B-B of FIG. 27. FIGS. 29F, 29G and 26H are cross-sectional views of processes employed in the method of manufacturing the TFT substrate 10 of the semi-transparent reflective-type LCD, taken along the line B-B of FIG. 27. A conceptual diagram of configurations of the TFT substrate 10, a plan view of a panel, a cross-sectional view of the panel in the seventh embodiment are the same as those in the fifth embodiment (FIG. 1 to FIG. 3) and their descriptions are omitted accordingly. In the seventh embodiment, an example is shown in which the TFT substrate 10 of the third embodiment is employed as the TFT substrate 10 in the semi-transparent reflective-type LCD of the seventh embodiment which corresponds to a pixel portion existing on a most outside surrounding portion on a leftmost side in FIG. 1. Configurations shown in FIGS. 7A to 7E can be used also in the seventh embodiment.

The method for manufacturing the TFT substrate 10 having above configurations is made up of six processes including, as shown in FIG. 28A to FIG. 29H, (1) a process of forming a metal film for a gate electrode 41 and of performing patterning on the metal film of the gate electrode 41, (2) a process of forming a gate insulating film 53, a-Si layer 44a, and n⁺-type a-Si layer 44b, metal films for a drain electrode 42 and a source electrode 43, and of performing patterning on them, and of performing patterning of the n⁺-type a-Si layer 44b and a-Si layer, (3) a process of forming a passivation film 54 and an insulating film 55, of performing patterning on them and of changing a shape of a surface of the insulating film 55, (4) a process of forming a transparent conductive film for the pixel electrode 101 and of performing patterning on the transparent conductive film of the pixel electrode 101, (5) a process of performing patterning on the passivation film 54, and (6) a process of forming a metal film for the reflective electrode 31 and performing patterning on the metal film of the reflective electrode 31.

First, by totally the same method as used in the third embodiment, the TFT is formed and the passivation film 54 and the insulating film 55 are formed on the TFT (FIGS. 28A to 25E, FIGS. 7A to 7C).

Next, a transparent conductive film made of ITO having a thickness of 40 nm to 100 nm is formed by sputtering and then patterning is performed using photolithography to form a pixel electrode 101 (see FIG. 29F and FIG. 7C).

Next, by totally the same method as used in the third embodiment, contact holes 56, 62, and 65 (not shown) are formed in the passivation film 54 (see FIG. 29G and FIG. 7D).

Then, a metal film having a high melting point such as Cr or Mo and having a thickness of 50 nm to 200 nm and Al—Nd alloy film having a thickness of 100 nm to 300 nm are sequentially formed by sputtering and then patterning is performed using photolithography on the above films to form the reflective electrode 31, terminal portion connecting electrodes 63 and connecting electrodes (not shown) to complete the manufacturing of the TFT substrate 10 (FIG. 29H and FIG. 7E).

In the seventh embodiment, the film configurations of the reflective electrode 31 and each of the connecting electrodes 66 and 83 described in the fifth embodiment are employed and also the material for the Al alloy used in the first embodiment is used. Cross-sectional views of the signal line 12 and the signal line drawing wiring 64 in the seventh embodiment, though not shown here, are the same as those shown in FIGS. 8A to 8F except that the n⁺-type a-Si layer 44b and a-Si layer 44a are stacked below the signal line 12 in a manner so as to have the same configuration as the signal 12.

Thereafter, by the same method as used in the first embodiment, the LCD panel is manufactured and the reflective-type LCD of the present invention is finished

Eighth Embodiment

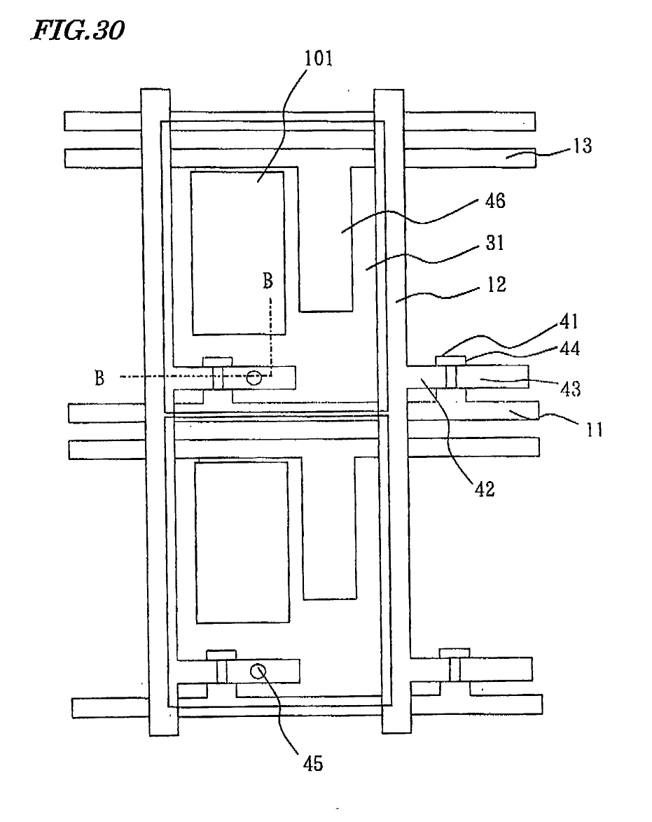

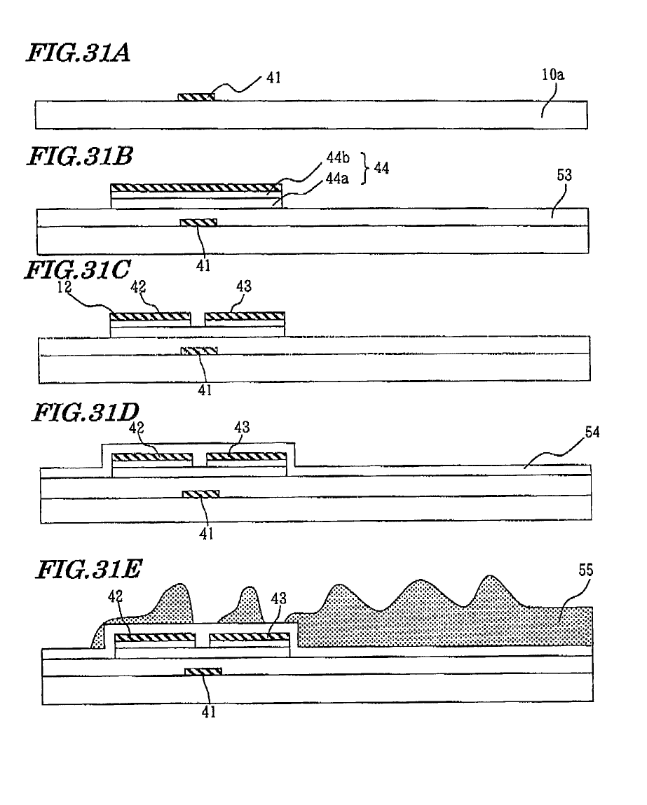

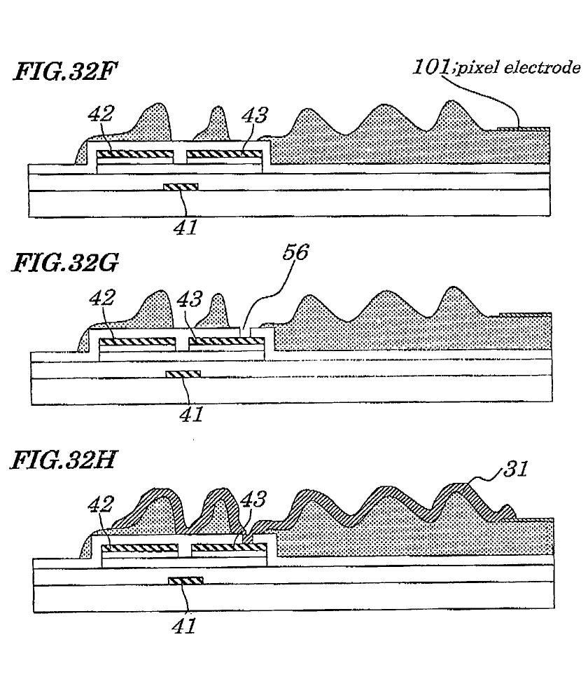

A semi-transparent reflective-type LCD of an eighth embodiment will be described by referring to FIG. 30 to FIGS. 32F to 32H. FIG. 30 is a plan view of configurations of one pixel portion on a TFT substrate 10 of a semi-transparent reflective-type LCD according to a seventh embodiment of the present invention. FIGS. 31A to 31E are cross-sectional views of processes employed in a method of manufacturing the TFT substrate of the semi-transparent reflective-type LCD, taken along a line B-B of FIG. 30. FIGS. 32F, 32G and 32H are cross-sectional views of processes employed in the method of manufacturing the TFT substrate 10 of the semi-transparent reflective-type LCD, taken along the line B-B of FIG. 30. A conceptual diagram of configurations of the TFT substrate 10, a plan view of a panel, a cross-sectional view of the panel in the eighth embodiment are the same as those in the fifth embodiment (FIG. 1 to FIG. 3) and their descriptions are omitted accordingly. In the seventh embodiment, an example is shown in which the TFT substrate 10 of the first embodiment is employed as the TFT substrate 10 in the semi-transparent reflective-type LCD of the fifth embodiment which corresponds to a pixel portion existing on a most outside surrounding portion on a leftmost side in FIG. 1. Configurations shown in FIGS. 7A to 7E and FIGS. 8A to 8F can be used also in the seventh embodiment.

The method for manufacturing the TFT substrate 10 having above configurations is made up of six processes including, as shown in FIG. 31A to FIG. 32H, (1) a process of forming a metal film for a gate electrode 41 and of performing patterning on it, (2) a process of forming a gate insulating film 53, a-Si layer 44a and n⁺-type a-Si layer 44b, metal films for a drain electrode 42 and a source electrode 43, and of performing patterning on the metal film of a drain electrode 42 and the metal film of a source electrode 43, n⁺-type a-Si layer 44b, and a-Si layer 44a, on the drain electrode 42 and source electrode 43 (channel forming), (3) a process of forming a passivation film 54 and insulating film 55, of performing patterning on them and of changing a shape of a surface of the insulating film 55, (4) a process of forming a transparent conductive film for a pixel electrode 101 and of performing patterning on the transparent conductive film of the pixel electrode 101, (5) a process of performing patterning on the passivation film 54, and (6) a process of forming a metal film for a reflective electrode 31 and of performing patterning on the metal film of the reflective electrode 341.

First, by totally the same method as used in the fourth embodiment, the TFT is formed and the passivation film 54 and the insulating film 55 are formed on the TFT (see FIGS. 31A to 31E, FIGS. 7A to 7C).

Next, a transparent conductive film made of ITO having a thickness of 40 nm to 100 nm is formed by sputtering and then patterning is performed using photolithography to form a pixel electrode 101 (see FIG. 32F and FIG. 7C).

Then, by the same method as used in the fourth embodiment, contact holes 56, 62 (not shown), and 65 (not shown) are formed in the passivation film 54 (see FIG. 32G and FIG. 7D).

Then, a metal film having a high melting point such as Cr or Mo and having a thickness of 50 nm to 200 nm and Al—Nd alloy film having a thickness of 100 nm to 300 nm are sequentially formed by sputtering and patterning is performed using photolithography on the above films to form the reflective electrode 31, terminal portion connecting electrodes 63 and connecting electrodes 66 (not shown) to complete the manufacturing of the TFT substrate 10 (FIG. 32H and FIG. 7E).

In the eighth embodiment, the film configurations of the reflective electrode 31 and each of the connecting electrodes 66 and 83 described in the fifth embodiment are employed and also the material for the Al alloy used in the first embodiment is used. Cross-sectional views of the signal line 12 and the signal line drawing wiring 64 in the eighth embodiment, though not shown here, are the same as those shown in FIGS. 8A to 8F except that the n⁺-type a-Si layer 44b and a-Si layer 44a are stacked below the signal line 12 in a manner so as to have the same configuration as the signal 12.

Thereafter, by the same method as used in the first embodiment, the LCD panel is manufactured and the reflective-type LCD of the present invention is finished

Thus, in the semi-transmissive reflective-type LCD, since a transparent pixel electrode has to be formed, unlike in the case of the reflective-type LCD as shown in the first to fourth embodiments, though the number of the photo-processes cannot be reduced, by using an Al alloy as a material for the terminal connecting electrode, it is not necessary to leave an ITO film at a terminal portion and therefore it is possible to reduce a risk of occurrence of peeling of Al film caused by a cell reaction between the ITO film and the Al alloy film described above. Moreover, it is needless to say that, in the fifth to eighth embodiments, the terminal portion connecting electrode may be formed using ITO. In this case, the process of forming the pixel electrode has to be performed after the contact holes have been formed.

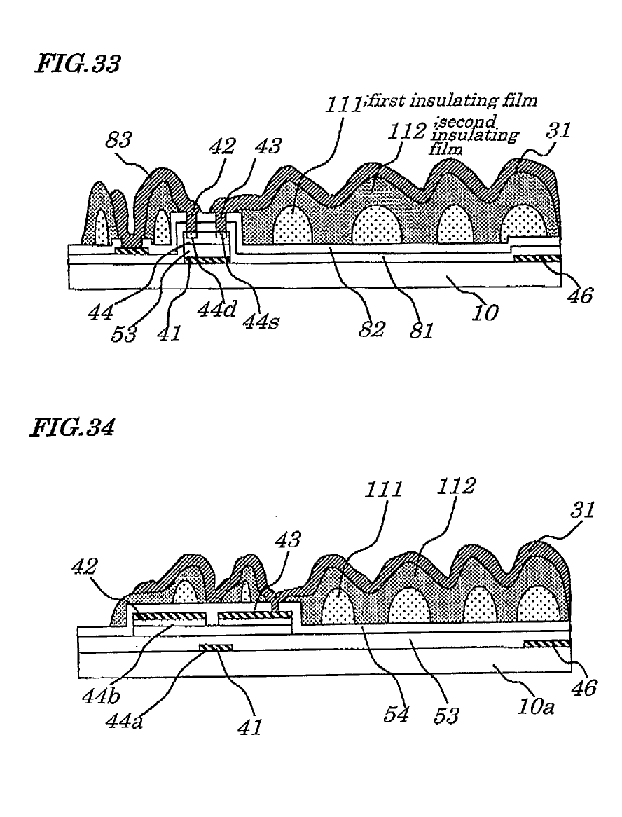

Moreover, in the above embodiments, an example is shown in which gentle convex and concave portions and contact holes are simultaneously formed using the insulating film 55, however, as shown in FIG. 33 to FIG. 36, the convex and concave portions are formed by a first insulating film 111 and planarization and forming of contact holes may be performed using a second insulating film 112.

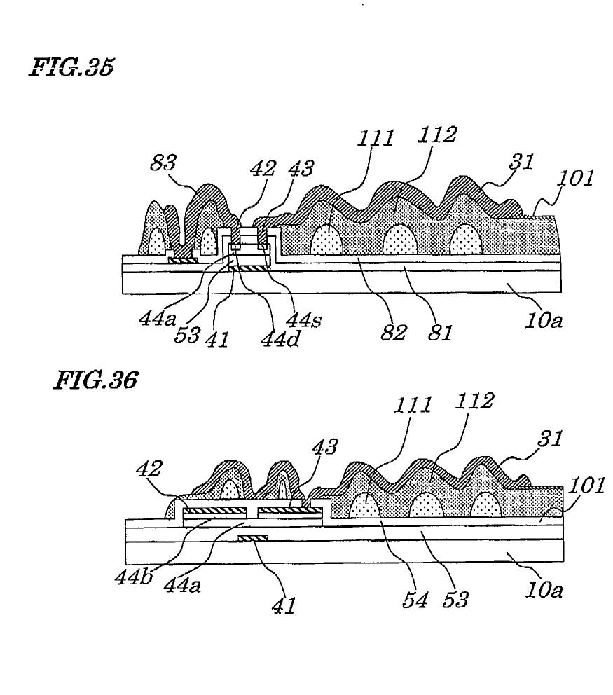

FIG. 33 is a cross sectional view of the TFT portion obtained when the manufacturing method using each of the first insulating film 111 and second insulating film 112 separately is applied to the second embodiment (that is, cross-sectional view taken along a line B-B in a plan view of the one pixel portion). FIG. 34 is a cross sectional view of the TFT portion obtained when the manufacturing method using each of the first insulating film 111 and second insulating film 112 separately is applied to the third and fourth embodiments (that is, cross-sectional view of the TFT portion, taken along the line B-B in a plan view of the one pixel portion). FIG. 35 is a cross sectional view of the TFT portion obtained when the manufacturing method using each of the first insulating film 111 and second insulating film 112 separately is applied to the sixth embodiment (that is, cross-sectional view of the TFT portion, taken along the line B-B in a plan view of the one pixel portion). FIG. 36 is a cross sectional view of the TFT portion obtained when the manufacturing method using each of the first insulating film 111 and second insulating film 112 separately is applied to the seventh and eighth embodiments (that is, cross-sectional view of the TFT portion, taken along the line B-B in a plan view of the one pixel portion).

This manufacturing process is performed in each of the above embodiments in a following manner. For example, coat of a photosensitive novolac resin with a thickness of 1 μm to 3 μm is put on a substrate and patterning using photolithography and using an alkaline developing agent is performed to form the first insulating film 111 in an irregular manner in a display region. As the first insulating film 111, both a resin being photosensitive and a resin being not photosensitive may be used. Formation in the case of using the non-photosensitive resin includes (1) a process of putting coat of the first insulating film 111 on a substrate, (2) a process of putting a resist to be used for patterning on the first insulating film 111, (3) a process of performing exposure, (4) a process of performing development, (5) a process of performing etching and (6) a process of peeling off a resist- On the other hand, the formation in the case of using the photosensitive resin includes (1) a process of putting coat of the first insulating film 111, (2) a process of performing exposure, and (3) a process of performing development and therefore the processes of forming the resist and peeling off the resist can be omitted.

Next, by the same method as used in the first embodiment, the process of changing a shape of a surface is performed on the first insulating film 111 to form a gentle convex portion.

Then, for example, coat of photosensitive novolac resin with a thickness of 0.3 μm to 1.5 μm is put on a substrate and patterning using photolithography and an alkaline developing agent and is performed and burning is performed at about 200° C. to 250° C. to form the second insulating film 112, while a pixel portion contact hole 45 (not shown) is formed so as to correspond to a contact hole 56 (not shown) formed on the passivation film 54 on the source electrode 43.

In the embodiment, as the material for the first insulating film 111 and the second insulating film 112, the novolac organic resin is used. For example, “PC403” manufactured by JSR Co., in Japan. However, use of a material of a same kind for the insulating film 111 and the second insulating film 112 is not required and a material of a different kind may be used. Moreover, not only single use of the novolac resin but also combined use of an inorganic resin and an organic resin such as a combination of an acrylic resin and a polyimide resin, a combination of a silicon nitride film and an acrylic resin, a combination of a silicon oxide film and a polyimide resin are employed to form a desired convex and concave portion.

Moreover, in the above embodiments, an example is shown in which the formation of the contact hole of the insulating film 55 or the second insulating film 112 and the formation of the gate insulating film 53 and contact hole of the passivation film 54 or contact holes of the first protective film 81 and second protective film 82 are performed by a separate process. However, by performing dry etching, at a high selective rate, on the gate insulating film 53 and passivation film 54, or the first protective film 81 and second protective film 82, using the insulating film 55 or the second insulating film 112 as a mask, it is possible to reduce the number of photo-processes by one process.

Moreover, in the above embodiments, each of the scanning line terminal 15, signal line terminal 16, and common line terminal 18 is constructed of the terminal portion lower layer metal film 61 formed at the same time when the scanning line 11 is formed and the terminal portion connecting electrode 63 being connected through the terminal portion contact hole 62 to the terminal portion lower layer metal film 61, however, in the second and sixth embodiments, except a case in which the second protective film 82 is not formed, the terminal portion lower layer metal film 61 may be formed at the same time when the signal line 12 is formed. If the terminal portion lower layer metal film 61 is formed at the same when the scanning line 11 is formed, since the gate insulating film 53 is stacked, the terminal portion lower layer metal film 61 becomes more resistant against a crack, when compared with a case in which it is formed at the same time when the signal line 12 is formed, thus improving reliability.

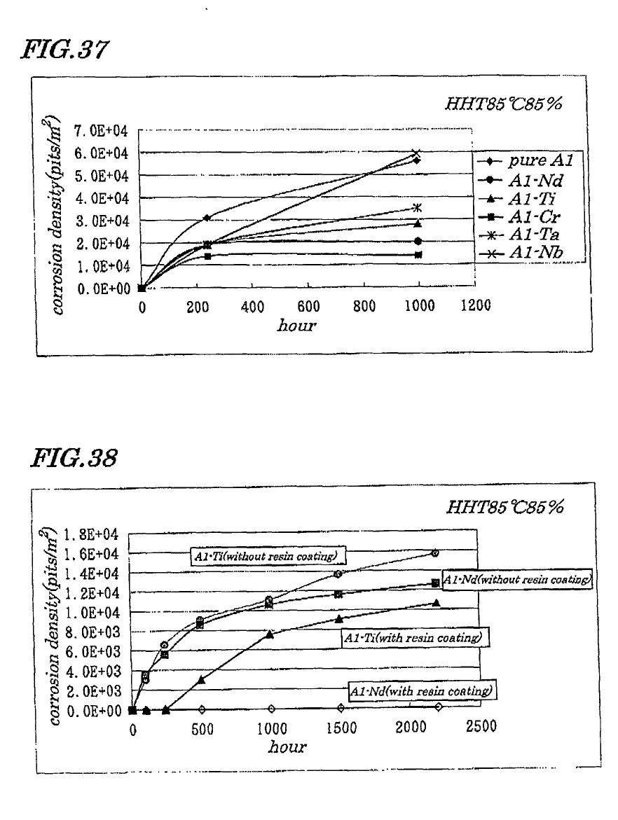

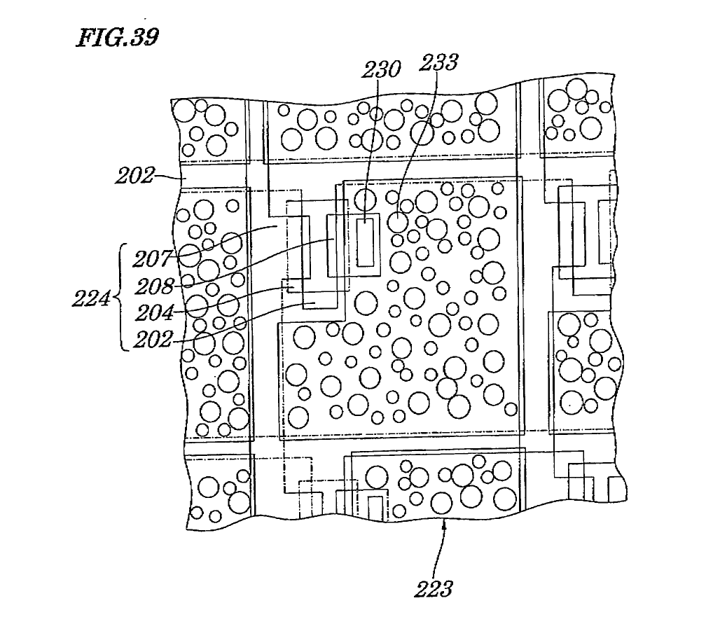

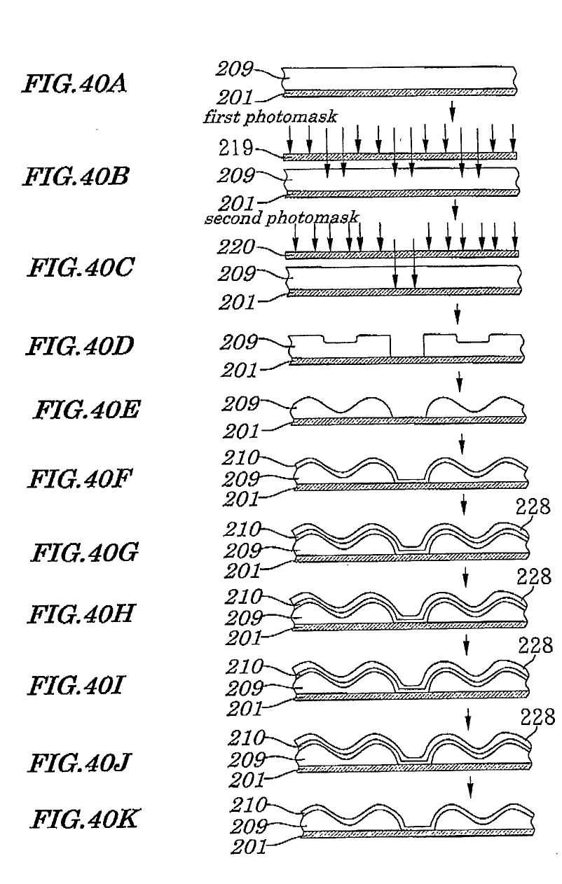

Finally, data on which designation of values employed in the present invention will be described. FIG. 37 is a graph showing a time-varying change in pitting corrosion density of pure Al and various Al alloys. Test results of changes in the pitting corrosion density obtained when, as metals of the terminal portion connecting electrode, pure Al, an Al—Nd (0.9% by atom) alloy, Al—Ti (2% by atom) alloy, Al—Cr (2% by atom) alloy, Al—Ta (2% by atom) alloy, and Al—Nb (2% by atom) alloy are used indicate that, in the case of using pure Al and an Al—Nb alloy, when 1000 hours elapse in the test at a high temperature of 85° C. and at a high humidity of 85%, pitting corrosion density is remarkably high, while, in the case of using Al—Cr alloy and Al—Nd alloy, when 200 hours to 1000 hours elapse in the above test, pitting corrosion density remains constant (that is, being saturated) . Therefore, the Al—Cr alloy or Al—Nd alloy is preferably used. Moreover, when the Al—Ti alloy or Al—Ta alloy is used, the pitting corrosion density can be reduced to a half or less, compared with a case in which the pure Al or Al—Nb alloy is used.

FIG. 38 is a graph showing time-varying changes in pitting corrosion density of the Al—Nd alloy film and Al—Ti alloy film. Test results of changes in the pitting corrosion density obtained when, as metals of the terminal portion connecting electrode, an Al—Nd (0.9% by atom) alloy (with resin coating), Al—Nd (0.9% by atom) alloy (without resin coating), Al—Ti (2% by atom) alloy (with resin coating), and Al—Ti (2% by atom) alloy are used indicate that, by providing the resin coating, resistance against corrosion can be improved.

In the case of using the Al—Nd alloy, when 2000 hours elapse in the test at a high temperature of 85° C. and at a high humidity of 85%, pitting corrosion does not occur. When the resin coating is not provided, since a diameter of a pitting corrosion is about 10 μm to 70 μm, by coating the resin with the Al—Nd alloy, reliability can be remarkably improved.

It seems that the pitting corrosion is caused by a chemical change from Al to aluminum hydroxide (Al(OH)₃) or aluminum oxide (Al₂O₃) due to ions.

Therefore, by using an alloy of Al and any of Nd, Ti, Cr, and Ta or alloy of Al and a plurality of these elements, as the material of the terminal portion connecting electrode, reliability in connection at the terminal portion can be improved. When Nd is singly added to the Al alloy, the alloy preferably contains 0.9% or more by atom of Nd. When other elements are added to the Al alloy, the alloy preferably contains 2% or more, in a total amount, by atom of other elements.

Thus, in the reflective-type LCD or in the semi-transmissive reflective-type LCD of the present invention, since the reflective electrode and least one connecting portion of the terminal portion connecting electrode are consisting essentially of an alloy of Al and Nd, Al and Ti, Al and Cr, or Al and Ta in any case of which the alloy mainly contains Al or of an alloy of Al and a plurality of elements including Nd, Ti, Cr, and Ta, in which the alloy mainly contains Al and in which the alloy contains 2% or more by atom of these elements or the alloy contains 0.9% or more by atom of Nd, reliability in connection in terminal portions can be ensured and the number of processes for the TFT can be reduced.

It is apparent that the present invention is not limited to the above embodiments but may be changed and modified without departing from the scope and spirit of the invention. For example, in the above embodiments, as the switching element, inverted staggered-type TFT is used, however, a forward staggered-type TFT may be used. Moreover, not only the staggered-type TFT but also coplanar-type TFT may be used. Also, a polycrystalline (p-Si) TFT can be used. As the switching element, instead of the TFT, an MIM (Metal Insulator Metal) may be used. Furthermore, as the substrate having the switching element and facing substrate, instead of glass substrate, other substrates such as a plastic substrate, ceramic substrate, semiconductor substrate (except in the case of the semi-transmissive reflective type LCD) or a like may be employed.

What is claimed is:

1. A method for manufacturing a liquid crystal display serving as a reflective-type liquid crystal display having a reflective electrode formed on one substrate out of a pair of substrates being placed in such a manner to face each other with a liquid crystal layer being interposed between said pair of said substrates and operating to reflect incident light emitted from an other substrate on which said reflective electrode is not formed, said method comprising:
a process of simultaneously forming said reflective electrode and a terminal portion connecting electrode to be formed in a terminal portion both being made up of an alloy mainly containing Al and being excellent in resistance against pitting corrosion or of both a metal having a high melting point and an alloy mainly containing Al being excellent in resistance against pitting corrosion formed and stacked in a layer on said metal having a high melting point.

2. A method for manufacturing the liquid crystal display according to claim 1, wherein an element or elements to be added to said alloy containing mainly Al include any one of Nd (Neodymium), Ti (Titanium), Cr (Cromium), and Ta (Tantalum), or at least one group selected from groups consisting essentially of a plurality of elements including Nd, Ti, Cr, and Ta.

3. The method for manufacturing the liquid crystal display according to claim 2, wherein said alloy contains 2% or more, in a total amount, of said plurality of said elements to be added to said alloy.

4. The method for manufacturing the liquid crystal display according to claim 3, wherein said alloy contains 0.9% or more by atom of said Nd.

5. The method for manufacturing the liquid crystal display according to claim 1, wherein a connecting portion in which said terminal portion connecting electrode is connected to an external driving circuit is coated with a resin.

6. The method for manufacturing the liquid crystal display according to claim 1, comprising:
a process of forming a gate electrode, a scanning line, and a terminal portion lower metal layer on a transparent insulating substrate;
a process of forming a gate insulating film on an entire surface of said transparent insulating substrate and then forming a semiconductor layer in a position being opposite to said gate electrode;
a process of forming a source electrode, a drain electrode, and a signal line;
a process of forming a passivation film on an entire surface of said transparent insulating substrate and then forming an insulating film on said passivation film and forming, by changing an integration value of an amount of exposure for every specified region, contact holes in said insulating film over said source electrode and forming, at a same time, convex and concave portions in a display region;
a process of forming contact holes in said passivation film over said source electrode and said terminal portion lower layer metal film; and
a process of simultaneously forming said reflective electrode to be connected to said source electrode and said terminal portion connecting electrode to be connected to said terminal portion lower layer metal film, both being made up of an alloy mainly containing Al or of both a metal having a high melting point and an alloy mainly containing Al and being formed and stacked in a layer on said metal having a high melting point.

7. The method for manufacturing the liquid crystal display according to claim 1, further comprising:
a process of forming a gate electrode, a scanning line, and a terminal portion lower layer metal film on a transparent insulating substrate;
a process of sequentially forming a gate insulating film, a semiconductor layer, and a metal layer in this order on said transparent insulating substrate and forming, by using a photoresist having a plurality of regions each having a different thickness which has been formed by changing an integration value of an amount of exposure for every specified region, a source electrode and a drain electrode after having formed a signal line and said semiconductor layer;
a process of forming a passivation film on an entire surface of said transparent insulating substrate and then a first insulating film on said passivation film and forming convex and concave portions in a display region;
a process of forming a second insulating film on an entire surface of said transparent insulating substrate and forming contact holes in said second insulating film on said source electrode and, at a same time, of removing at least said second insulating film on said terminal portion lower layer metal film;
a process of forming contact holes in said source electrode and in said passivation film over said terminal portion lower layer metal film; and
a process of forming a reflective electrode to be connected to said source electrode and said terminal portion connecting electrode to be connected to said terminal portion lower layer metal film both being made up of an alloy mainly containing Al or a metal having a high melting point and an alloy mainly containing Al being formed and stacked on said metal having a high melting point.

8. The method for manufacturing the liquid crystal display according to claim 6, wherein both said process of forming contact holes in said first insulating film or said second insulating film and said process of forming said contact holes in said passivation film or in said protective film are performed by one time etching.

9. A method for manufacturing a liquid crystal display serving as a semi-transmissive reflective-type liquid crystal display having a reflective electrode formed on one substrate out of a pair of substrates being placed in such a manner to face each other with a liquid crystal layer being interposed between said pair of said substrates and operating to reflect incident light emitted from an other substrate on which said reflective electrode is not formed and having a pixel electrode through which incident light enters from a side of said one substrate passes, said method comprising:
a process of simultaneously forming said reflective electrode and a terminal portion connecting electrode to be formed in a terminal portion both being made up of a metal having a high melting point and an alloy mainly containing Al and being excellent in resistance against pitting corrosion and being formed and stacked in a layer on said metal having a high melting point.

10. A method for manufacturing the liquid crystal display according to claim 9, wherein an element or elements to be added to said alloy containing mainly Al include any one of Nd (Neodymium), Ti (Titanium), Cr (Cromium), and Ta (Tantalum), or at least one group selected from groups consisting essentially of a plurality of elements including Nd, Ti, Cr, and Ta.

11. The method for manufacturing the liquid crystal display according to claim 10, wherein said alloy contains 2% or more, in a total amount, of said plurality of said elements to be added to said alloy.

12. The method for manufacturing the liquid crystal display according to claim 11, wherein said alloy contains 0.9% or more by atom of said Nd.

13. The method for manufacturing the liquid crystal display according to claim 9, wherein a connecting portion in which said terminal portion connecting electrode is connected to an external driving circuit is coated with a resin.

14. The method for manufacturing the liquid crystal display according to claim 9, comprising:
a process of forming a gate electrode, a scanning line, and a terminal portion lower layer metal film on a transparent insulating substrate;
a process of forming a gate insulating film on an entire surface of said transparent insulating substrate and forming a semiconductor layer in a position being opposite to said gate electrode;
a process of forming a source electrode, a drain electrode, and a signal line;
a process of forming a passivation film on an entire surface of said transparent insulating substrate and then forming an insulating film on said passivation film and forming, by changing an integration value of an amount of exposure for every specified region, contact holes in said insulating film over said source electrode and, at a same time, convex and concave portions in a display region;
a process of forming contact holes in said passivation film over said source electrode and said terminal portion lower layer metal film;
a process of forming a pixel electrode made up of a transparent conductive film; and
a process of simultaneously forming said reflective electrode to be connected to said source electrode and said pixel electrode, and said terminal portion connecting electrode to be connected to said terminal portion lower layer metal film, both being made up of both a metal having a high melting point and an alloy mainly containing Al being formed and stacked in a layer on said metal having a high melting point.

15. The method for manufacturing the liquid crystal display according to claim 9, further comprising:
a process of forming a gate electrode, a scanning line, and a terminal portion lower layer metal film on a transparent insulating substrate;
a process of sequentially forming a gate insulating film, a semiconductor layer, and a metal layer in this order on said transparent insulating substrate and forming, by using a photoresist having a plurality of regions each having a different thickness which has been formed by changing an integration value of an amount of exposure for every specified region, a source electrode and a drain electrode after having formed a signal line and a semiconductor layer;
a process of forming a passivation film on an entire surface of said transparent insulating substrate and then a first insulating film and forming convex and concave portions in a display region;
a process of forming a second insulating film on an entire surface of said transparent insulating substrate and forming contact holes in said second insulating film on said source electrode and, at a same time, of removing at least said second insulating film on said terminal portion lower layer metal film;
a process of forming a pixel electrode made up of a transparent conductive film;
a process of forming contact holes in said source electrode and in said passivation film on said terminal portion lower layer metal film; and
a process of forming a reflective electrode to be connected to said source electrode and to said pixel electrode and said terminal portion connecting electrode to be connected to said terminal portion lower layer metal film both being made up of both a metal having a high melting point and an alloy mainly containing Al being formed and stacked in a layer on said metal having a high melting point.

16. The method for manufacturing the liquid crystal display according to claim 14, wherein both said process of forming contact holes in said first insulating film or said second insulating film and said process of forming said contact holes in said passivation film or in said protective film are performed by one time etching.

17. A method for manufacturing a liquid crystal display comprising:
a process of sequentially forming a metal layer, a gate insulating film, and a semiconductor layer, in this order, on a transparent insulating substrate and forming, by using a photoresist having a plurality of regions each having a different thickness which has been formed by changing an integration value of an amount of exposure for every specified region, a stacked-layer film made up of a gate electrode, said gate insulating film, and a semiconductor layer each having a same shape as said gate electrode, and a scanning line and a terminal portion lower layer metal film;
a process of forming a signal line after having formed a protective film on an entire surface of said transparent insulating substrate;
a process of forming a first insulating film on an entire surface of said transparent insulating substrate and forming convex and concave portions in a display region;
a process of forming a second insulating film on an entire surface of said transparent insulating substrate and forming contact holes in places facing each other on said semiconductor layer and in said second insulating film on a signal line existing in a vicinity and, at a same time, of removing at least said second insulating film on said terminal portion lower layer metal film;
a process of forming contact holes in places facing each other on said semiconductor layer and in said protective film on said terminal portion lower layer metal film;
a process of doping said semiconductor layer with an element having a valence of V through said contact hole formed in said protective film to form a source region and a drain region; and
a process of integrally forming a source electrode and a reflective electrode to be connected to said source region and a drain electrode to be connected to said drain region, and a connecting electrode connecting said drain electrode to said signal line, all of which are made up of both a metal having a high melting point and an alloy mainly containing Al being formed and stacked in a layer on said metal having a high melting point.

18. The method for manufacturing the liquid crystal display according to claim 17, further comprising a process of simultaneously forming both said terminal portion connecting electrode being formed on a terminal portion and being connected to said terminal portion lower metal film and said reflective electrode.

19. The method for manufacturing the liquid crystal display according to claim 17, wherein, in said processes of forming said first and second insulating films, both said process of forming convex and concave portions in said first insulating film and said process of forming contact holes in said second insulating film are simultaneously performed by changing an integration value of an amount of exposure for every specified region.

20. The method for manufacturing the liquid crystal display according to claim 17, wherein both said process of forming contact holes in said first insulating film or said second insulating film and said process of forming said contact holes in said passivation film or in said protective film are performed by one time etching.

21. A method for manufacturing a liquid crystal display comprising:
a step of sequentially forming a metal layer, a gate insulating film, and a semiconductor layer, in this order, on a transparent insulating substrate and then forming, by using a photoresist having a plurality of regions each having a different thickness which has been formed by changing an integration value of an amount of exposure for every specified region, a stacked-layer film made up of a gate electrode, said gate insulating film, and a semiconductor layer each having a same shape as said gate electrode, and a scanning line and a terminal portion lower layer metal film;
a process of forming a signal line after having formed a protective film on an entire surface of said transparent insulating substrate;
a process of forming a first insulating film on an entire surface of said transparent insulating substrate and forming convex and concave portions in a display region;
a process of forming a second insulating film on an entire surface of said transparent insulating substrate and forming contact holes in places facing each other on said semiconductor layer and in said second insulating film on a signal line existing in a vicinity and, at a same time, of removing at least said second insulating film on said terminal portion lower layer metal film;
a process of forming a pixel electrode made up of a transparent conductive film;
a process of forming contact holes in places facing each other on said semiconductor layer and in said protective film on said terminal portion lower layer metal film;
a process of doping said semiconductor layer with an element having a valence of V through said contact hole formed in said protective film to form a source region and a drain region; and
a process of integrally forming a source electrode to be connected to said source region and a reflective electrode to be connected to said pixel electrode, a drain electrode to be connected to said drain region, and a connecting electrode connecting said drain electrode to said signal line, all of which are made up of both a metal having a high melting point and an alloy mainly containing Al being formed and stacked in a layer on said metal having a high melting point.

22. The method for manufacturing the liquid crystal display according to claim 21, further comprising a process of simultaneously forming both said terminal portion connecting electrode being formed on a terminal portion and being connected to said terminal portion lower metal film and said reflective electrode.

23. The method for manufacturing the liquid crystal display according to claim 21, further comprising a process of simultaneously forming both said terminal portion connecting electrode being formed on a terminal portion and being connected to said terminal portion lower metal film and said pixel electrode.

24. The method for manufacturing the liquid crystal display according to claim 21, wherein, in said processes of forming said first and second insulating films, both said process of forming convex and concave portions in said first insulating film and said process of forming contact holes in said second insulating film are simultaneously performed by changing an integration value of an amount of exposure for every specified region.

25. The method for manufacturing the liquid crystal display according to claim 21, wherein both said process of forming contact holes in said first insulating film or said second insulating film and said process of forming said contact holes in said passivation film or in said protective film are performed by one time etching.

26. A method for manufacturing a liquid crystal display comprising:
a process of forming a gate electrode, a scanning line, and a terminal portion lower layer metal film on a transparent insulating substrate;
a process of sequentially forming a gate insulating film, a semiconductor layer, and a metal layer in this order, on said transparent insulating substrate and then forming, by using a photoresist having a plurality of regions each having a different thickness which has been formed by changing an integration value of an amount of exposure for every specified region, a semiconductor layer after having formed a source electrode, a drain electrode, and a signal line;
a process of forming a passivation film on an entire surface of said transparent insulating substrate and then a first insulating film and forming convex and concave portions in a display region;
a process of forming a second insulating film on an entire surface of said transparent insulating substrate and forming contact holes in said second insulating film on said source electrode and, at a same time, of removing at least said second insulating film on said terminal portion lower layer metal film;
a process of forming contact holes in said passivation film over said source electrode and said terminal portion lower layer metal film; and
a process of simultaneously forming a reflective electrode to be connected to said source electrode made up of an alloy mainly containing Al or of both a metal having a high melting point and an alloy mainly containing Al being formed and stacked on said metal having a high melting point.

27. The method for manufacturing the liquid crystal display according to claim 25, further comprising a process of simultaneously forming both said terminal portion connecting electrode being formed on a terminal portion and being connected to said terminal portion lower metal film and said reflective electrode.

28. The method for manufacturing the liquid crystal display according to claim 25, further comprising a process of simultaneously forming both said terminal portion connecting electrode being formed on a terminal portion and being connected to said terminal portion lower metal film and said pixel electrode.

29. The method for manufacturing the liquid crystal display according to claim 25, wherein, in said processes of forming said first and second insulating films, both said process of forming convex and concave portions in said first insulating film and said process of forming contact holes in said second insulating film are simultaneously performed by changing an integration value of an amount of exposure for every specified region.

30. The method for manufacturing the liquid crystal display according to claim 25, wherein both said process of forming contact holes in said first insulating film or said second insulating film and said process of forming said contact holes in said passivation film or in said protective film are performed by one time etching.

31. A method for manufacturing a liquid crystal display comprising:
a process of forming a gate electrode, a scanning line, and a terminal portion lower layer metal film on a transparent insulating substrate;
a process of sequentially forming a gate insulating film, a semiconductor layer, and a metal layer in this order and then forming, by using a photoresist having a plurality of regions each having a different thickness which has been formed by changing an integration value of an amount of exposure for every specified region, a semiconductor layer after having formed a source electrode, a drain electrode, and a signal line;
a process of forming a passivation film on an entire surface of said transparent insulating substrate and then a first insulating film and then forming convex and concave portions in a display region;
a process of forming a second insulating film on an entire surface of said transparent insulating substrate and forming contact holes in said second insulating film over said source electrode and, at a same time, of removing at least said second insulating film on said terminal portion lower layer metal film;
a process of forming a pixel electrode made up of a transparent conductive film;
a process of forming contact holes in said source electrode and in said passivation film over said terminal portion lower layer metal film; and
a process of forming said source electrode and said reflective electrode to be connected to said reflective electrode both being made up of both a metal having a high melting point and an alloy mainly containing Al being formed and stacked in a layer on said metal having a high melting point.

32. The method for manufacturing the liquid crystal display according to claim 31, further comprising a process of simultaneously forming both said terminal portion connecting electrode being formed on a terminal portion and being connected to said terminal portion lower metal film and said reflective electrode.

33. The method for manufacturing the liquid crystal display according to claim 31, further comprising a process of simultaneously forming both said terminal portion connecting electrode being formed on a terminal portion and being connected to said terminal portion lower metal film and said pixel electrode.

34. The method for manufacturing the liquid crystal display according to claim 31, wherein, in said processes of forming said first and second insulating films, both said process of forming convex and concave portions in said first insulating film and said process of forming contact holes in said second insulating film are simultaneously performed by changing an integration value of an amount of exposure for every specified region.

35. The method for manufacturing the liquid crystal display according to claim 31, wherein both said process of forming contact holes in said first insulating film or said second insulating film and said process of forming said contact holes in said passivation film or in said protective film are performed by one time etching.

36. A liquid crystal display serving as a reflective-type liquid crystal display having a reflective electrode being formed on one substrate out of a pair of substrates being placed in such a manner to face each other with a liquid crystal layer being interposed between said pair of said substrates and operating to reflect incident light emitted from an other substrate on which said reflective electrode is not formed, wherein said reflective electrode and a terminal portion connecting electrode being formed at a terminal portion are made up of an alloy mainly containing Al being excellent in pitting corrosion or of both a metal having a high melting point and an alloy mainly containing Al being excellent in pitting corrosion and being formed and stacked in a layer on said alloy having a high melting point.

37. The liquid crystal display according to claim 36, wherein an element or elements to be added to said alloy containing mainly Al include any one of Nd, Ti, Cr, and Ta, or at least one group selected from groups consisting essentially of a plurality of elements including Nd, Ti, Cr, and Ta.

38. The liquid crystal display according to claim 37, wherein said alloy contains 2% or more, in a total amount, of said elements to be added to said alloy.

39. The liquid crystal display according to claim 41 to claim 37, wherein said alloy contains 0.9% or more by atom of Nd.

40. A method for manufacturing a liquid crystal display serving as a semi-transmissive reflective-type liquid crystal display having a reflective electrode being formed on one substrate out of a pair of subtrates being placed in such a manner to face each other with a liquid crystal layer being interposed between said pair of said substrates and operating to reflect incident light emitted from an other substrate on which said reflective electrode is not formed and having a pixel electrode through which incident light entered from a side of said one substrate passes, wherein both said reflective electrode and a terminal portion connecting electrode being formed on a terminal portion are made up of a metal having a high melting point and an alloy mainly containing Al being excellent in pitting corrosion and being formed and stacked in a layer on said alloy having a high melting point.

41. The liquid crystal display according to claim 40, wherein an element or elements to be added to said alloy containing mainly Al include any one of Nd, Ti, Cr, and Ta, or at least one group selected from groups consisting essentially of a plurality of elements including Nd, Ti, Cr, and Ta.

42. The liquid crystal display according to claim 41, wherein said alloy contains 2% or more, in a total amount, of said elements to be added to said alloy.

43. The liquid crystal display according to claim 41 to claim 22, wherein said alloy contains 0.9% or more by atom of Nd.
